(19) United States
(12) Patent Application Publication
(10) Pub. No.: US 2020/0226302 A1
(43) Pub. Date: Jul. 16, 2020

(54) Driveline Designer

(71) Applicant: ROMAX TECHNOLOGY LIMITED, Nottinghamshire (GB)

(72) Inventors: Barry James, Nottingham (GB); Sharad Jain, Nottingham (GB); Kathryn Taylor, Nottingham (GB); Maik Hoppert, Leipzig (DE)

(21) Appl. No.: 16/650,412

(22) PCT Filed: Sep. 26, 2018
(86) PCT No.: PCT/IB2018/057466

§ 371 Date: Mar. 25, 2020

(30) Foreign Application Priority Data
Sep. 26, 2017 (GB) 1715567.2

(51) Int. Cl. G06F 30/17; G06F 30/15; G06F 30/20; G01M 13/00; F16H 57/00

(52) U.S. Cl. CPC G06F 30/17; G06F 30/15; G06F 2111/10; G01M 13/00; F16H 57/00; G06F 30/20

(57) ABSTRACT

A computer-implemented method for modelling a driveline. The driveline comprising a plurality of components. The method comprising the steps of: a) receiving a parametric description of the driveline; b) creating a tribology model of the driveline from the parametric description; c) calculating one or more traction coefficients for one or more components of the driveline using the tribology model; and d) calculating a performance metric of the driveline, based on the parametric description and the one or more traction coefficients.

### TECHNICAL FIELD

The present invention is related to the design of drivelines using computer-aided engineering (CAE), and in particular to the effects of lubricant performance on the design.

Drivelines comprise a system made up of a plurality of components that may include internal combustion engines, gearboxes, transmissions, driveshafts, constant velocity joints, universal joints, axles, differentials, electric machines, generators, motors, flywheels, batteries, fuel tanks, super-capacitors, fuel cells, inverters, converters, clutches, gears, pumps, shafts, housings, pistons, blades, bearings, rotors, stators and the like. Applications of drivelines can include vehicles, turbines, marine vessels, aircraft, helicopters, and wind turbines.

### BACKGROUND ART

The principal function of the driveline is to transmit mechanical rotational power, and for electro-mechanical drivelines also to convert power from electrical to mechanical, or the other way round. This needs to be done as efficiently as possible, with minimal power loss.

These critical design targets for drivelines, the avoidance of gear failure due to fatigue or scuffing, avoidance of bearing failure due to fatigue, the minimisation of gear whine and the maximisation of driveline efficiency, are what the driveline design engineer has to achieve to the best of their abilities within the design process.

GB2506532A discloses an approach in which key engineering parameters of the driveline are defined in a single parametric model, including form, function, operating conditions, and properties. These are defined in a parametric description that allows rapid redefinition of the design, allowing rapid design-analyse-redesign iterations according to the results of a multiplicity of physical simulations.

### DISCLOSURE OF INVENTION

This invention is a computer-implemented method allowing engineers to understand the design of any or all of the three sub-systems of gearbox, motor and power electronics within a mechanical or electro-mechanical driveline through simulation in order that the driveline performance can be predicted, understood and improved through design modifications. The invention focuses on how the lubricant influences aspects of physical behaviour such as bearing skidding, gear mesh power loss and bearing drag.

The invention provides to the design engineer insight on the influence of the lubricant and how it affects the other aspects of driveline performance so that designs can be optimised and confirmed as fit for purpose with a productivity not previously possible. Time and money is saved in the bringing of new products to market and also the problem resolution in existing products. Most importantly, there is the potential to further safeguard human life.

According to a first aspect, there is provided a computer-implemented method for modelling a driveline, the driveline comprising a plurality of components, the method comprising the steps of:

a) receiving a parametric description of the driveline;

b) creating a tribology model of the driveline from the parametric description;

c) calculating one or more traction coefficients for one or more components of the driveline using the tribology model; and

d) calculating a performance metric of the driveline, based on one or both of the parametric description and the one or more traction coefficients.

Creating a tribology model may comprise one or more of the following steps:

running a dynamic model using data from the parametric description in order to determine dynamic-data;

determining a lubricant film thickness parameter by processing the dynamic-data and also the parametric description;

determining a lubrication regime based on the lubricant film thickness parameter;

identifying a traction model that is appropriate for the determined lubrication regime; and

processing the traction model, the parametric description and the dynamic-data to calculate at least a subset of the traction coefficients.

Calculating the performance metric may comprise building a performance-metric-model. The method may further comprise: creating the tribology model and building the performance-metric-model such that they have a common structure.

The method may further comprise:

comparing the performance metric with one or more loop-end-conditions; and

if the one or more loop-end-conditions are not satisfied, then:
updating the parametric description based on the performance metric.

The method may further comprise one or more of the following steps:
creating a thermal model of the driveline from the parametric description;
calculating a temperature distribution for one or more components of the driveline using the thermal model; and
calculating the performance metric of the driveline based on one or both of the temperature distribution and the one or more traction coefficients.

The method may further comprise: creating the tribology model of the driveline from the parametric description and also based on the temperature distribution.

The method may further comprise: creating the thermal model of the driveline from the parametric description and also based on the one or more traction coefficients.

The method may further comprise one or more of the following steps: determining a deflection of one or more components of the driveline caused by the thermal distribution, based on the parametric description and the temperature distribution; and
calculating the performance metric of the driveline based on one or both of the one or more traction coefficients and the determined deflection of the one or more components.

The method may further comprise one or more of the following steps:
creating an efficiency model of the driveline from the parametric description;
calculating an efficiency metric using the efficiency model;
calculating the performance metric of the driveline based on one or both of the efficiency metric and the one or more traction coefficients.

The method may further comprise: creating the efficiency model of the driveline from the parametric description and also based on the one or more traction coefficients.

The method may further comprise one or more of the following steps:
creating a thermal model of the driveline from the parametric description;
calculating a temperature distribution for one or more components of the driveline using the thermal model;

calculating the performance metric of the driveline based on one or both of the temperature distribution and the one or more traction coefficients.

The method may further comprise: creating the thermal model of the driveline from the parametric description and also based on the one or more traction coefficients and/or the efficiency metric.

The method may further comprise: creating the efficiency model of the driveline from the parametric description and also based on the temperature distribution for one or more components of the driveline.

The method may further comprise one or more of the following steps:
creating a structural model of the driveline from the parametric description;
determining a deflection of one or more components of the driveline based on the structural model; and calculating the performance metric of the driveline based on one or both of the one or more traction coefficients and the determined deflection of the one or more components.

The method may further comprise: creating the tribology model of the driveline from the parametric description and also based on the determined deflection of the one or more components.

The method may further comprise one or more of the following steps:
creating a thermal model of the driveline from the parametric description;
calculating a temperature distribution for one or more components of the driveline using the thermal model;

optionally, calculating the performance metric of the driveline also based on the temperature distribution.

The method may further comprise: creating the structural model of the driveline from the parametric description and also based on the temperature distribution.

The method may further comprise one or more of the following steps:
creating an efficiency model of the driveline from the parametric description;
calculating an efficiency metric using the efficiency model;
optionally, calculating the performance metric of the driveline also based on the efficiency metric.

The method may further comprise: creating the efficiency model of the driveline also based on one or more of: the temperature distribution, the traction coefficients, and the determined deflection of the one or more components.

The driveline may comprise at least one bearing. The method may further comprise one or more of the following steps:
calculating one or more traction coefficients for one or more components of the driveline using the tribology model, and also based on one or both of a temperature distribution and dynamic-data;
calculating a temperature distribution based on the parametric description of the driveline, and one or both of the traction coefficients and the dynamic-data;
calculating the dynamic-data based on the parametric description of the driveline, and one or both of the temperature distribution and the traction coefficients; and
calculating a bearing skidding performance metric of the driveline based on any or all of the parametric description, the one or more traction coefficients, the dynamic-data, and the temperature distribution.

The driveline may comprise at least one bearing. The method may further comprise one or more of the following steps:
building and running an analytical model of the bearing based on the parametric description to determine a bearing skidding map;
identifying operating points across the bearing's operating range based on the skidding map;
calculating one or more traction coefficients for one or more components of the driveline using the tribology model for the identified operating points, and also based on one or both of a temperature distribution and dynamic-data;
calculating a temperature distribution based on the parametric description of the driveline, and one or both of the traction coefficients and the dynamic-data;
calculating the dynamic-data based on the parametric description of the driveline, and one or both of the temperature distribution and the traction coefficients; and
calculating a bearing skidding performance metric of the driveline based on any or all of the parametric description, the one or more traction coefficients, the dynamic-data, and the temperature distribution.

The method may further comprise calculating bearing drag and/or clutch friction.

Calculating the bearing drag may comprise calculating bearing misalignment as a function of system deflections.

The parametric description of the driveline may include manufacturing tolerances.

There may be provided a computer readable product for computer-aided engineering design of a driveline, the product comprising code means for implementing the steps of any method disclosed herein.

There may be provided a computer system for computer-aided engineering design of a driveline, the system comprising means designed for implementing the steps of any method disclosed herein.

There may be provided a driveline designed using any method disclosed herein.

### BRIEF DESCRIPTION OF DRAWINGS

The present invention will now be described, by way of example only, with reference to the accompanying drawings, in which:

FIG. 1a shows how separate models can be used by separate CAE tools for separate failure mode analyses;

FIG. 1b shows how a parametric description of a driveline can be used to determine a plurality of performance metrics of the driveline;

FIG. 2a illustrates schematically an example of a parametric description;

FIG. 2b illustrates schematically a specific example of a parametric description;

FIG. 3 shows a schematic view of a process for designing a driveline;

FIG. 4 plots the dependence of the traction coefficient on slip speed, clearly showing three different regions: linear region where shear stress is below the Eyring shear stress; nonlinear region where the shear stress is greater than the Eyring shear stress and the traction coefficient increases to a maximum value; and the thermal region where shear stress causes the lubricant to heat up, and the resulting reduction in lubricant viscosity causes the traction coefficient to decrease;

FIG. 5 illustrates the process of FIG. 3 with more detail in the tribology modelling;

FIG. 6 shows a schematic view of another computer-implemented method for modelling a driveline, and optionally for designing a driveline;

FIG. 7 illustrates a further embodiment of the invention, in which the type of analysis is a thermal analysis;

FIG. 8 shows a schematic view of a process for modelling a driveline, in which the tribology model is combined with a thermal model and an efficiency model;

FIG. 9 illustrates a further embodiment of the invention, further including a structural model, which takes as an input the parametric description;

FIG. 10 illustrates a driveline modelling method which combines tribology, thermal modelling, efficiency, and structural modelling into one integrated process;

FIG. 11 shows a schematic view of a process for modelling a driveline, which can be considered as a numerical analysis for determining bearing skidding results;

FIG. 12 shows a schematic view of another process for modelling a driveline, which can be considered as a combination of: (i) the numerical analysis that was described above with reference to FIG. 11, and (ii) an analytical solution; and

FIG. 13 illustrates another representation of a parametric description formed of four non-overlapping data sets.

### BEST MODE FOR CARRYING OUT THE INVENTION

A computer-implemented method can be used for modelling a driveline, and in particular to perform one or more different types of analysis on a parametric description that is representative of the design of a driveline. Further details of how a parametric description can be implemented will be discussed below.

A driveline design engineer can aim to satisfy performance targets that relate to one or more of the following aspects (as non-limiting examples), to the best of their abilities, within the design process: (i) driveline efficiency, for instance in terms of efficiency of energy conversion as represented by energy/fuel consumption, (ii) the avoidance of gear failure due to fatigue or scuffing, (iii) the avoidance of bearing failure due to fatigue, and (iv) the minimisation of gear whine and the maximisation of driveline efficiency. Different types of analysis can be used to determine different performance metrics for the driveline, which can then be compared with associated performance targets. An ability to meet a performance target can also be considered as avoiding a “failure mode” of the driveline.

Simulation tools can be used to apply such analysis. For example, application-specific CAE tools for mechanical driveline design such as RomaxDESIGNER, MASTA and KissSoft predict gear fatigue to ISO 6336 and AGMA 2001, and bearing fatigue to various standards related to and derived from ISO 281. Gear scuffing is predicted and gear mesh losses are predicted using ISO TR14179 and other methods. All these methods have been developed specifically for gears and bearings and so they do not exist in generalist CAE tools such as finite element analysis (FEA), model-based definition (MBD), or multi-domain simulation.

In traditional CAE tools, CAD provides form (geometry) and some aspects of properties (for example, material density but not Young's modulus), but it does not include operating conditions or function. Models in MBD and FEA tools can include certain aspects of form, function, properties and operating conditions, but only those that are pertinent to the specific failure mode that is being simulated.

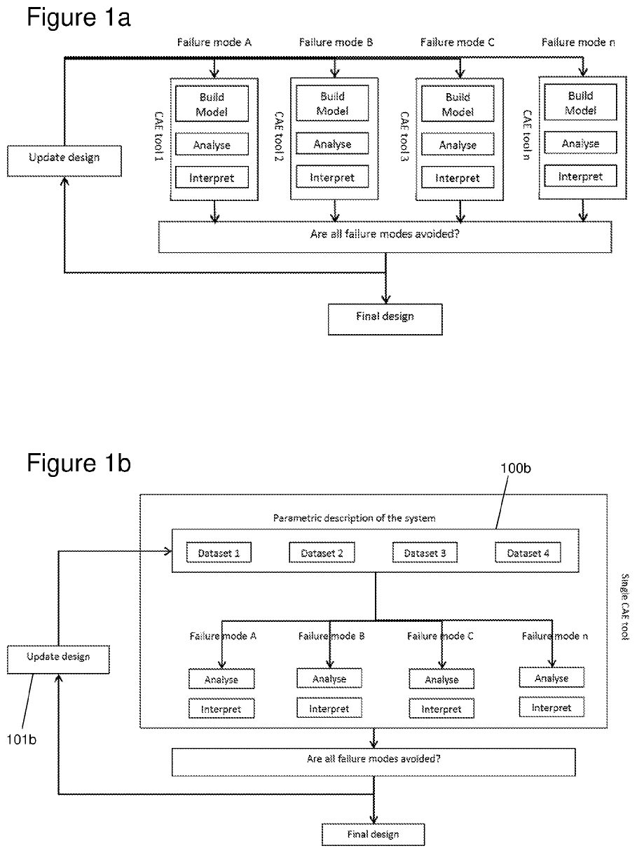

FIG. 1a shows how separate models can be used by separate CAE tools, such that each of the models can be used to determine a performance metric of the driveline, and hence whether or not a performance target is satisfied and a failure mode is avoided. This can involve comparing a performance metric with a performance target.

FIG. 1b shows how a parametric description 100b, such as the ones described below, can be used to determine a plurality of performance metrics of the driveline, and hence whether or not a plurality of performance targets are satisfied and failure modes avoided. In contrast to FIG. 1a, the parametric description 100b and single CAE tool of FIG. 1b advantageously do not require an individual model to be built manually for each CAE functionality, and also do not require data to be moved between the different CAE functionalities. In contrast, a mathematical model can be built for each analysis type, automatically selecting data from the parametric description 100b.

FIG. 1b illustrates how the invention addresses discontinuities in the workflow that can occur in traditional CAE tools, where a parametric description with multiple types of datasets is not available. The CAE tool of FIG. 1b can run a plurality of simulations to determine the performance metrics of the driveline or the likelihood of the different failure modes. The results of each of these simulations arise from mathematical models of the operating performance of the driveline, with each physical phenomenon requiring a different algorithm, and all algorithms being available within the single CAE tool so as to maximise engineering productivity.

FIG. 1b shows schematically a step 101b of updating the design of the driveline. This can involve comparing one or more performance metrics that are calculated by the CAE tool with one more performance targets. If a performance target is not satisfied, such that an associated failure mode is not avoided, then the software can update the design at step 101b by adjusting the parametric description 100b. Then the CAE tool can be applied to the new parametric description 100b to determine whether or not all of the failure modes are avoided for the new design. Further details of how the design can be updated will be provided below.

In various of the examples described below, a single parametric description of the driveline can be used, from which multiple models for multiple performance metrics and failure mode analyses can be derived.

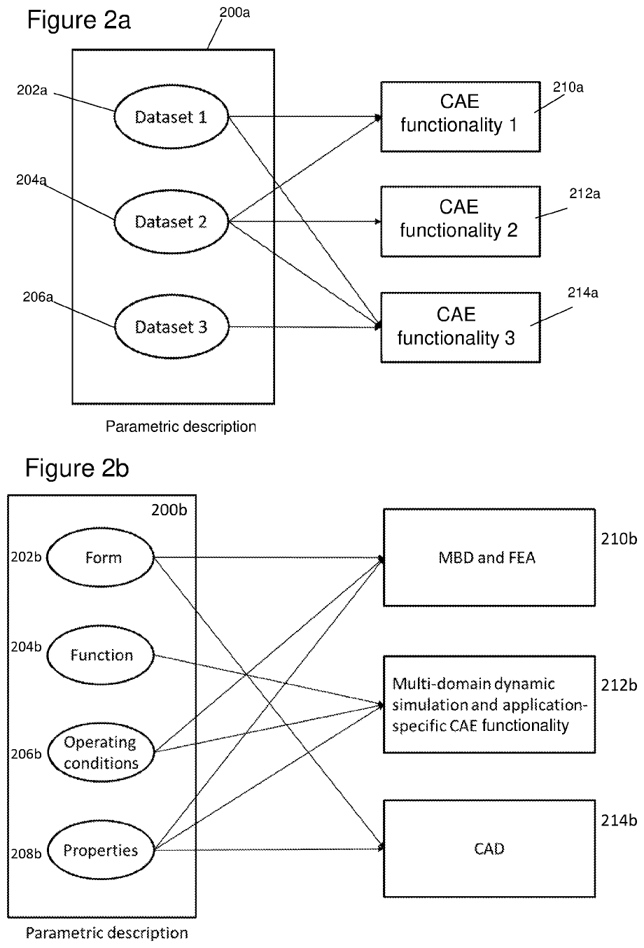

FIG. 2a illustrates schematically an example of a parametric description 200a. The parametric description 200a includes a plurality of datasets 202a, 204a, 206a, one or more of which can be used to perform a different CAE functionality 210a, 212a, 214a. Traditionally, each CAE functionality is provided by a separate CAE tool, each carrying out a different type of analysis. The parametric description 200 can comprise a collection of data (the datasets 202a, 204a, 206a) that defines the driveline and optionally also how the driveline will be operated.

FIG. 2b illustrates schematically a specific example of a parametric description 200b, which is similar to that of FIG. 2a. The CAE functionalities shown in FIG. 2b are: MBD and FEA 210, Multi-domain dynamic simulation and application-specific CAE functionalities 212, and CAD 214.

In this example, the “parametric description” 200b includes the following datasets: form 202b, function 204b, properties 208b, and operating conditions 206b. These datasets can be non-overlapping.
Form 202b can include data relating to geometry.
Properties 208b can include the material properties of the components, plus component specific properties such as the dynamic capacity of a bearing, the surface roughness of a gear tooth flank, the viscosity of a lubricant, the Goodman diagram of a shaft material, the resistivity of electric machine windings etc.
Operating conditions 206b can include principally the power, speed, torque of the rotating machinery, either as a time history or a residency histogram, but can also include temperature, humidity etc.
Function 204b can define the way in which the product, sub-systems and components perform their primary function—for example, the function of a roller bearing is to provide support to a shaft whilst allowing it to rotate, assemble a shaft and a bearing together and the combined function is to provide a rotating shaft to which loads can be applied, mount a gear on the shaft, mesh it with a similarly mounted gear and the combined function is to change speed and torque.

The table below is a tabular representation of FIG. 2b, with the same reference numbers used for convenience. In this way, the table shows what data from the parametric description 200b is used by the different CAE functionalities to perform different types of analysis.

| | 200b Parametric description | | | |
|---|---|---|---|---|
| | | | 206b | |
| | 202b | 204b | Operating | 208b |
| CAE functionality | Form | Function | conditions | Properties |
| 210b | Yes | | Yes | Yes |
| MBD & FEA | | | | |
| 212b | | Yes | Yes | Yes |
| Multi-domain dynamic | | | | |
| simulation; | | | | |
| Application-specific CAE | | | | |
| functionality | | | | |
| 214b | Yes | | | Yes |
| CAD | | | | |

Importantly the above table, and also FIGS. 2a and 2b, show that one parametric description 200a, 200b can enable multiple analysis types to be performed in one CAE tool, rather than needing a separate tool for each analysis.

Traditional CAE tools can each only provide one CAE functionality. In order to perform that functionality the tools may require a subset of the information that is provided by the parametric description that is described above. For example: CAD 214b provides form (geometry) 202b and some aspects of properties 208b (for example, material density but not Young's modulus), but does not include operating conditions 206b or function 204b. MBD and FEA functionalities 210b require models that include certain aspects of form 202b, function 204b, properties 208b and operating conditions 206b, but only those that are pertinent to the specific failure mode that is being simulated. Models in multi-domain dynamic simulation and application-specific CAE functionalities 212b use the aspects of function 204b, properties 208b and operating conditions 206b that are pertinent to the specific failure mode that is being simulated, but no form 202b.

Depending on which CAE functionality 210b, 212b, 214b is employed, the engineer has to select data from one or more of the four data sets to create an analytical model suitable for the analysis being performed.

Advantageously, examples described herein can include a single CAE tool that can perform multiple CAE functionalities. This is, at least in part, due to the single parametric description that provides a common source of information for the different CAE functionalities.

As has been described, a multiplicity of simulations is required to ensure that a driveline is not only fit for purpose, but performs as well as possible so as to be competitive in the marketplace, and cheap to bring to market and manufacture so as to maximise profits as well as ensuring safety where necessary.

One or more of the examples described below relate to a process of modelling or designing a driveline based on a parametric description of the driveline. The process advantageously calculates one or more traction coefficients using a tribology model of the driveline, and then calculates a performance metric of the driveline based on the parametric description and the traction coefficients. Advantageously, this can enable a more accurate performance metric to be calculated, because the processing can take into account the traction coefficients.

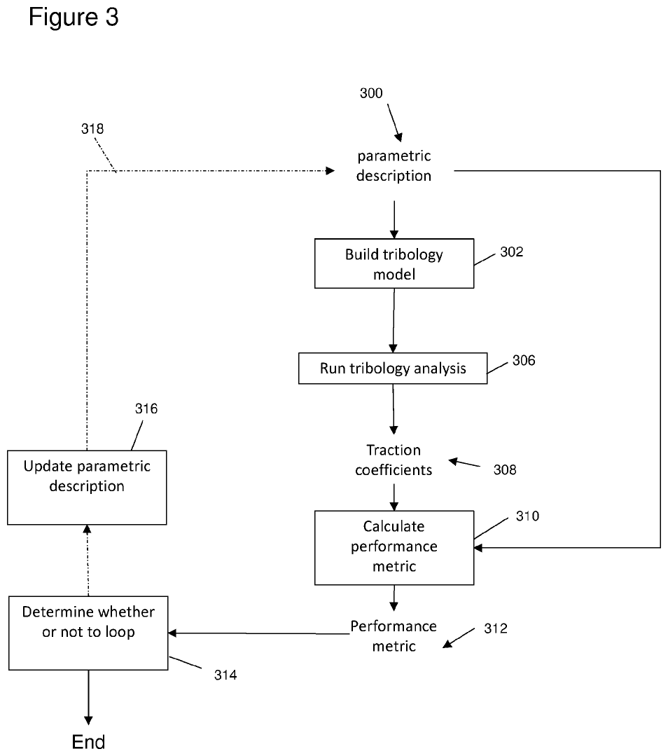

FIG. 3 shows a schematic view of a process for designing a driveline. The process receives a parametric description 300, for example of the kind disclosed in Table 1 above, or shown schematically in FIGS. 1 and 2. In a step 302, the process builds a tribology model using data from the parametric description 300.

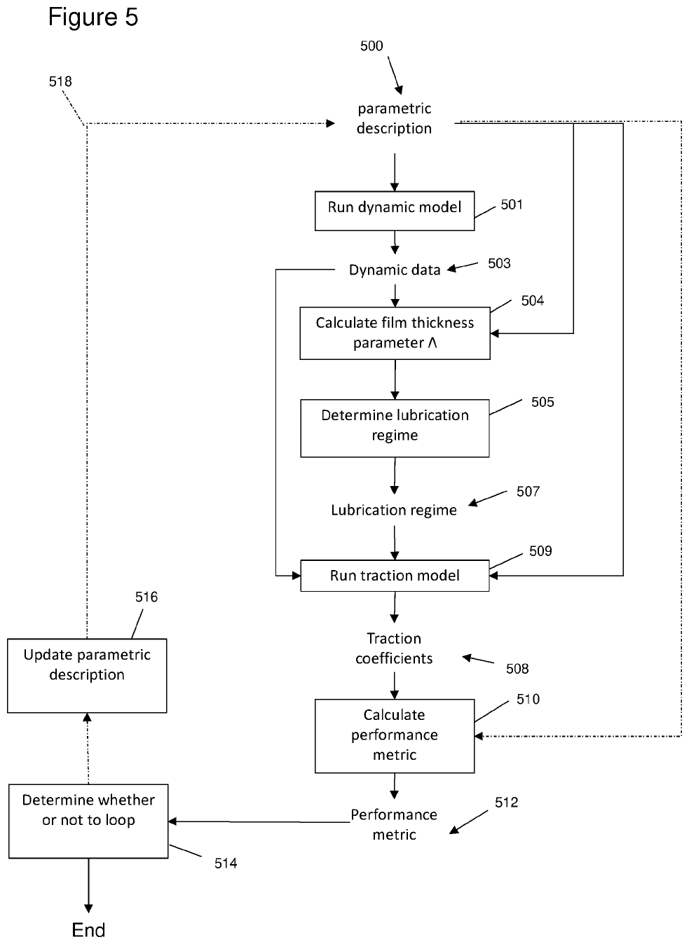

In a step 306, the process runs the tribology model and calculates one or more traction coefficients 308 for one or more components in the driveline. The process can calculate more than one traction coefficient for a given component in some applications, for example different traction coefficients for different lubrication regimes or different operating conditions. Further details of one example of how the tribology model can be built and run are provided below with reference to FIG. 5.

The performance of the driveline is evaluated in step 310 of FIG. 3 by means of calculating one or more performance metrics 312 of the driveline. The calculation in step 310 uses the traction coefficients 308 and the parametric description 300 as inputs. The output of step 310 is a performance metric 312. Examples of a performance metric 312 include efficiency, power loss, temperature distribution, misalignment between different parts of components in the driveline, durability, bearing skidding, and transmission error. Examples of how such performance metrics 312 can be calculated are provided below.

In some examples, calculating the performance metric 312 can include building a performance-metric-model. Various examples of such models are described below, and can include a thermal model, an efficiency model and a structural model, as non-limiting examples. The processing of FIG. 3 can include creating the tribology model at step 302 and building the performance-metric-model at step 310 such that they have a common structure. Further details of such common structures will be provided below.

In the embodiment of FIG. 3, the process includes an optional step of determining whether or not to loop at step 314. At step 314, the process can compare the performance metric 312 with one or more loop-end-conditions. If the one or more loop-end-conditions are not satisfied, then the method moves on to step 316 to update the parametric description 300 and then repeats the method of FIG. 3. If the one or more loop-end-conditions are satisfied, then the method ends.

Non-limiting examples of how loop-end-conditions can be applied include:
Determining a rate of convergence for the value that is being compared with the loop-end-conditions, and comparing the rate of convergence with a threshold-value that is indicative of the value being sufficiently settled. If the threshold-value is satisfied, then determining that the loop-end-condition has been satisfied. In this way, the loop can be repeated until the values do not change within a user-specified tolerance.
Determining a number of iterations around the loop that have been performed, and comparing this number with a maximum number of iterations. If the maximum number has been reached, then determining that the loop-end-condition has been satisfied.
Comparing the value that is being compared with the loop-end-conditions with a threshold-value that represents acceptable performance, and if the threshold-value is satisfied then determining that the loop-end-condition has been satisfied.
Determining the difference between the performance metric 312 for the current iteration of the loop with the value of the same performance metric 312 calculated on the previous iteration of the loop, and comparing this difference with a threshold-value that represents acceptable convergence. If the difference between the performance metric value 312 on consecutive loops is less than the threshold-value, them determining that the loop-end-condition has been satisfied.

This “difference” can be an absolute difference or a relative difference (for example expressed as a percentage). In this way, the iterative loop can stop iterating when the value is within 1%, for example, of its value from the previous iteration.

Application of this iterative loop can be considered as a design process, since the parametric description 300 is modified based on the calculated performance metric 312, thereby redesigning the driveline based on the calculated performance metric 312.

The tribology model that is built at step 302 can include a lubrication model and/or a traction model. In some examples, lubrication models and traction models can be collectively described as tribology models. Further details of such models will now be provided.

Lubrication models divide the behaviour of the contacting surfaces into different lubrication operating regimes, depending on the operating conditions. All surfaces are rough and are covered with asperities. Depending on their size, surface asperities could influence the mechanism of fluid-film formation in a contact. A lubricant film thickness parameter ∧ is generally used to establish which of several lubrication regimes applies in a contact zone. ∧ is defined as the ratio of the minimum film thickness to the surface roughness of the two contacting surfaces.

These are the four main lubrication operating regimes:
(i) Boundary lubrication. ∧<1 means that the minimum lubricant film thickness is less than the asperity height, so the two surfaces are in direct contact and the contact load is carried by surface asperities.
(ii) Mixed lubrication. 1<∧<3 means that the minimum lubricant film thickness is comparable to or greater than the asperity height, so the contact load is shared by asperities and the lubricant film.
(iii) Elasto-hydrodynamic (EHD) lubrication. A>3 means that the lubricant film is thicker than the asperity height, so the contact load is carried by the lubricant film, and the asperities on the two surfaces are fully separated. In the EHD lubrication regime the elastic deformation of the contacting solid surfaces is significant.
(iv) Hydrodynamic lubrication. ∧>10 means that the surfaces are sufficiently separated that elastic deformation is no longer significant.

The film thickness ∧ can be calculated in different ways. Two examples are given below.
a) The equation derived by Nijenbanning, Venner, and Moes (as described in: Nijenbanning, G., Venner, C. H., Moes, H., & Moes, H. (1994). Film thickness in elastohydrodynamically lubricated elliptic contacts. Wear, 176(2), 217-229. DOI: 10.1016/0043-1648(94)90150-3) is based on a large number of numerical simulations covering a wide range of operating conditions, from rigid-isoviscous to elasto-hydrodynamic. The equation divides the operating range into four regions as a combination of two effects: the pressure dependency of the viscosity (isoviscous or piezoviscous); and the deformation of the contacting bodies (rigid or elastic).
b) The Hamrock-Dowson equations for EHD lubrication cover a smaller range of operating conditions, but are simpler to implement. These equations are described in: Fundamentals of Fluid Film Lubrication, 2nd Edition Bernard J. Hamrock, Steven R. Schmid, Bo O. Jacobson, CRC Press, published Mar. 15, 2004.

FIG. 5 illustrates the process of FIG. 3 with more detail in the tribology modelling. Step 302 in FIG. 3 of building a tribology model is represented by steps 501 and 504 in FIG. 5, and step 306 of running a tribology model in FIG. 3 is represented by steps 505 and 509 in FIG. 5.

In FIG. 5, at step 501 the process runs a dynamic model using data from the parametric description 500 in order to determine dynamic-data 503. In this example the dynamic-data 503 is representative of relative speeds and pressures at contact points in the drivetrain. For example, at step 501 the process can calculate the rotational speeds of all rotating elements in the drivetrain in order to determine the dynamic-data 503.

At step 504, the process can determine the lubricant film thickness parameter ∧ in any known way, including the two examples described above. This can involve processing the dynamic-data 503 and also data from the parametric description 500. Relevant data from the parametric description 500 can include operating conditions, lubricant properties, and surface roughness of the components. The process then uses the lubricant film thickness parameter ∧ calculated in step 504 to determine the lubrication regime in step 505. Then at step 509, the process identifies a traction model that is appropriate for the determined lubrication regime 507, and uses the traction model, the parametric description 500 and the dynamic-data 503 to calculate at least a subset of the traction coefficients 508.

The behaviour in each of the lubrication operating regimes 507 can be described by a sub-model, here referred to as a traction model. Tribology models can contain a) a means of determining the lubrication operating regime in step 505, for example by comparing the lubricant film thickness parameter ∧ to one or more threshold values, and b) one or more traction models 509, which govern behaviour within a given lubrication operating regime. The key properties of a traction model can include: a) that it should be applicable for any kind of rolling or sliding contact, b) that it should cover all operating conditions within the relevant operating regime, and c) that it should account for lubricant properties to distinguish between different lubricants. Advantageously, in some applications a plurality of traction models can be available for processing at step 509, for instance one traction model for each operating regime in the lubrication model. This can allow the full operating range of rolling and sliding contacts to be modelled.

When the lubrication regime 507 is EHD lubrication, the traction model that is run at step 509 can be an EHD lubrication traction model. Traction models for the EHD lubrication operating regime describe the relationship between shear rate and shear stress. One such traction model for EHD lubrication is the Eyring model. Eyring shear stress is defined as the shear stress below which the traction coefficient increases linearly with slip speed. When the shear stress exceeds the Eyring shear stress, the lubricant starts to behave in a non-linear manner. Eyring stress may be pressure- and/or temperature-dependent.

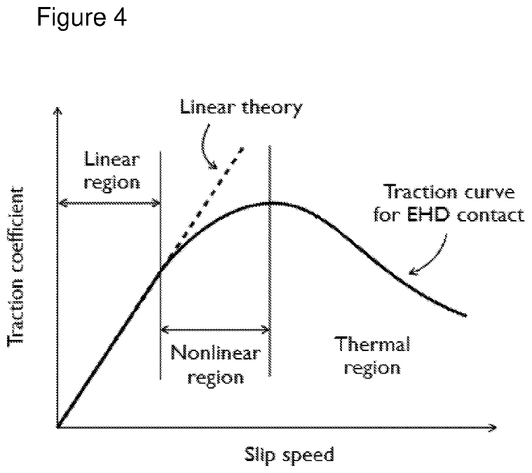

FIG. 4 plots an Eyring traction model that shows the dependence of the traction coefficient on slip speed. The Eyring traction model consists of three different traction regimes, according to the operating conditions:
(i) Linear traction regime. When the shear stress is below the Eyring shear stress, the traction coefficient increases linearly with slip speed.
(ii) Nonlinear traction regime. When the shear stress is greater than the Eyring shear stress at higher slip speeds, the relationship between the traction coefficient and the slip speed is no longer linear. The traction coefficient reaches a maximum value.
(iii) Thermal traction regime. As slip speed increases further, shear stress causes the lubricant to heat up. The resulting reduction in lubricant viscosity causes the traction coefficient to decrease.

In some applications, the dynamic-data 503 that is calculated at step 501 can include slip speed. The processing at step 509 can apply the Eyring traction model of FIG. 4 to the slip speed in order to calculate one or more traction coefficients 508 for the driveline.

Other Elasto-hydrodynamic lubrication (EHL) traction models that can be applied at step 509 include the Bair-Winer model (Bair S, Winer WO. A Rheological Model for Elastohydrodynamic Contacts Based on Primary Laboratory Data. ASME. J. of Lubrication Tech. 1979; 101(3):258-264. doi:10.1115/1.3453342.). The Bair-Winer model is a limiting shear stress model, in which if the shear stress of the lubricant exceeds the limiting value, the shear stress is set equal to the limiting value and a further increase in lubricant shear rate no longer results in an increase in shear stress. The required material properties for this model are low shear stress viscosity, limiting elastic shear modulus, and the limiting shear stress the material can withstand. All of these parameters are functions of the operating conditions (including temperature and pressure), and are defined in the parametric description 500. Shear stress can be calculated from the dynamic-data 503.

When the lubrication operating regime 507 is boundary lubrication, the traction model that is run at step 509 can be a boundary lubrication traction model. In the boundary lubrication regime, the film thickness ∧ is less than 1, which means that the minimum lubricant film thickness is less than the asperity height. The two surfaces are in direct contact and the contact load is carried by surface asperities. The surface contact results in high traction coefficients and the friction behaviour is similar to dry contact. Boundary lubrication is more likely to occur at low speeds and/or high loads, and is generally undesirable because of high friction losses and increased wear. Some lubricants contain anti-wear or extreme-pressure additives, which can react with surface asperities to form a sacrificial chemical coating which protects the metal underneath. Various boundary traction models exist, which aim to capture the dependency of traction coefficient on speed, load, temperature, atmospheric conditions, and lubricant additives. These parameters are inputs to the traction model 509 from the dynamic-data 503 and the parametric description 500.

When the lubrication operating regime 507 is mixed lubrication, the traction model that is run at step 509 can be a mixed lubrication traction model. Traction models for the mixed lubrication operating regime include FVA345 (Hohn, Bernd-Robert; Michaelis, Klaus; Doleschel, Andreas; Lubricant Influence on Gear Efficiency; Proceedings of the ASME 2009 International Design Engineering Technical Conferences & Computers and Information in Engineering Conference IDETC/CIE 2009). The FVA345 method is a mechanical test method developed at FZG Munich for determining the frictional behaviour of lubricants using a modified FZG gear test rig. The FVA345 method combines traction models for boundary lubrication and EHL. The traction coefficient μmixed is calculated by Equations 1 below.

μ_{mixed}=φ·μ_{EHL}+(1−φ)·μ_{boundary} (Equation 1a)

∧<2:φ=1−(1−∧/2) (Equation 1b)

∧/2:φ=1 (Equation 1c)

μ_{EHL}=c₁·p^{c}₂·v^{c}₃·η^{c}₄ (Equation 1d)

μ_{boundary}=c₅·p^{c}₆·v^{c}₇ (Equation 1e)

where μ_{EHL}, and μ_{boundary} are the traction coefficients in mixed lubrication regime, EHL regime, and boundary lubrication regime respectively, φ is the proportion of the traction coefficient due to EHL, ∧ is the film thickness, c₁ to c₇ are constant coefficients, p is pressure, v is speed and η is the lubricant viscosity. The pressure and speed are part of the dynamic-data 503, and the lubricant viscosity and the constant coefficients are defined in the parametric description 500. Both the dynamic-data 503 and the parametric description 500 are inputs into the traction model 509, here represented by Equations 1. The traction coefficients 508, as calculated here in Equations 1, are the output of the step of running the traction model 509. The traction coefficient μ_{mixed} is a combination of traction coefficients μ_{EHL} and μ_{boundary} (Equation 1 a). The proportion φ of the traction coefficient due to EHL depends on the film thickness ∧ and is given by Equations 1b and 1c. The traction coefficients μ_{EHL} and μ_{boundary} are given by Equations 1d and 1e, and depend on the pressure, speed, and in the case of EHL also the lubricant viscosity. The constant coefficients c₁ to c₇ can be derived from test data.

The use of a simple traction model such as FVA345 with coefficients that can be derived from test data has several advantages. It is straightforward to obtain the values of the coefficients—for FVA345 the seven coefficients c₁ to c₇ can be obtained from a low cost test with standard lab equipment. There is a benefit to lubricant manufacturers, in that the advantages of advanced lubricants can be seen in simulation without the need to disclose sensitive proprietary information about the lubricant formulation or additives. For the software user, the main advantage is that the lubricant properties can be fully accounted for in the simulation, even in the absence of lubricant data from the manufacturer, given a small sample of the lubricant that can be sent off for testing.

Empirical models for calculating traction coefficients are another option. One example is Benedict and Kelley (Benedict, G. H., and Kelley, B. W., 1961, “Instantaneous Coefficients of Gear Tooth Friction,” ASLE Transactions, Vol. 4, No. 1, pp 59-70). This empirical model describes only a small part of the operating range, covering traction behaviour within the operating conditions of the test from which it was derived. The model does not account for the lubricant viscosity or any other lubricant properties, so is not capable of differentiating between different lubricants. The use of tribology models as described above is generally preferable to empirical models of limited applicability.

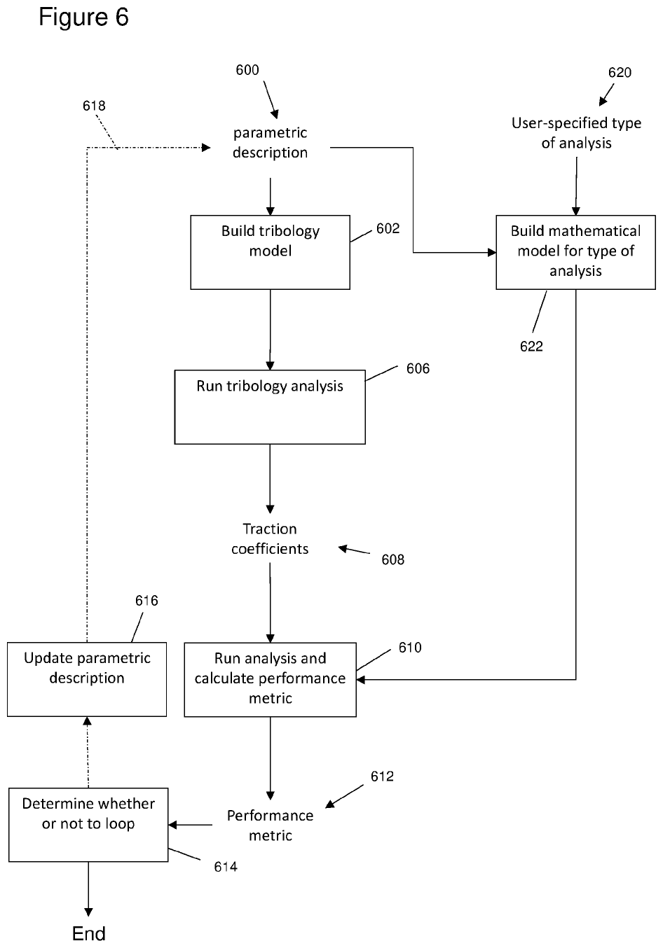

FIG. 6 shows a schematic view of another computer-implemented method for modelling a driveline, and optionally for designing a driveline. Features of FIG. 6 that have corresponding features in FIG. 3 will be given reference numbers in the 600 series and will not necessarily be described again here.

In the example of FIG. 6, the process receives an additional user-specified type of analysis 620. In a step 622, the method builds a mathematical model for the type of analysis based on the user-specified type of analysis 620 and the parametric description 600. The process then runs an analysis at step 610 based on the mathematical model that was built at step 622 and the traction coefficients 608 that are calculated based on a tribology model. Also at step 610, the process calculates a performance metric 612.

In one example, the user-specified type of analysis 620 is an efficiency analysis. Then, at step 622 the process builds an efficiency model as the mathematical model, based on the parametric description 600. The analysis that is run at step 610 is an efficiency analysis, and the performance metric 612 can be the efficiency or power loss of one or more components in the driveline. In this example, the efficiency analysis 610 uses the values of traction coefficients 608 that are calculated by running the tribology model 606.

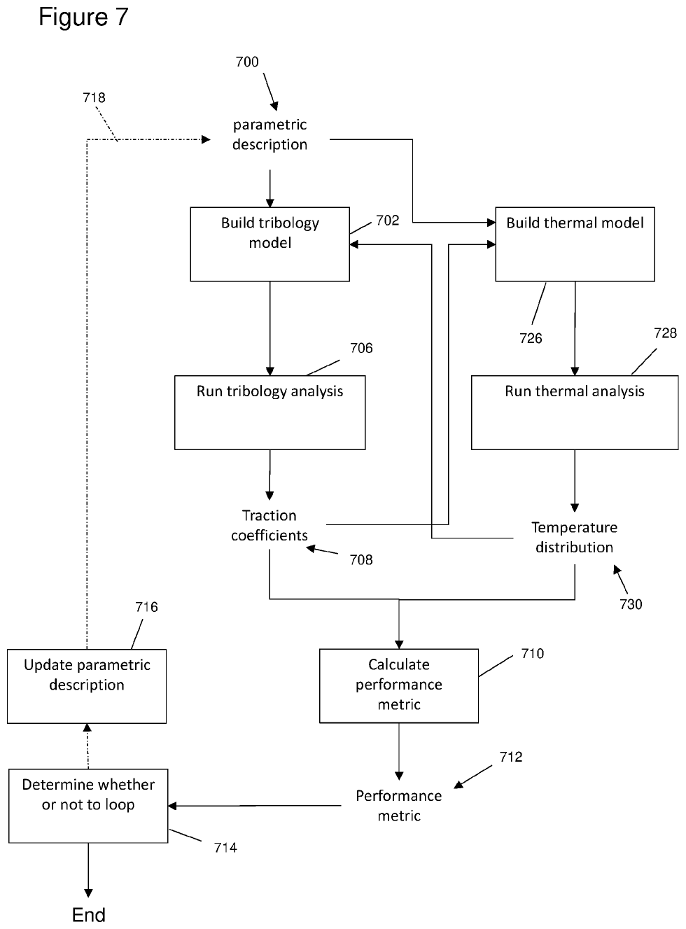

FIG. 7 illustrates a further embodiment of the invention, in which the type of analysis is a thermal analysis. Features of FIG. 7 that have corresponding features in an earlier figure will be given reference numbers in the 700 series and will not necessarily be described again here.

At step 726, the method creates a thermal model of the driveline from the parametric description 700. The thermal model can be a discrete thermal model or a continuous thermal model. Discrete thermal models can include lumped parameter thermal network models, and meshed finite element thermal models.

A discretised lumped parameter thermal network model of the driveline may contain thermal inertias or capacitances connected by thermal links, with heat sources providing an input of heat flux. Thermal links can include heat transfer due to conduction, convention, and radiation. The processing at step 726 can determine the properties of these capacitances and conductances, and their connections, from the parametric description 700 of the driveline and its components.

In some embodiments, the method can automatically process the parametric description to identify where there are power losses in the driveline in order to build the thermal model. For instance, the method can determine the power loss of one or more components in the driveline (optionally for specific operating conditions), and then determine whether or not the component should be modelled as a heat source based on the determined power loss value. For instance, if the power loss value is greater than a power-loss-threshold, then the component can be modelled as a heat source. The heat source can be included at a location in the model that corresponds to the location of the component that was determined to have the associated power losses. In this way, the method can recognise that heat will be generated at locations in the driveline where there are power losses. Locations of power losses can include places where there is friction between contacting surfaces (gears and bearings), current passing through wiring (e.g. electric machine stators and power electronics), drag losses at seals, or movement of fluid causing drag losses (churning or windage).

Optionally, the process can use the traction coefficients 708 to calculate the power losses in the driveline, which can then be used as inputs into building the thermal model at step 726. That is, at step 726, the process can build the thermal model also based on the calculated power losses. For the example of sliding friction, power loss can be calculated from traction coefficients using Equations 2:

Pₗₒₛₛ=F_{friction}·v (Equation 2a)

F_{friction}=μFₙₒᵣₘₐₗ (Equation 2b)

where Pₗₒₛₛ is the power loss, F_{friction} is the frictional force, v is the relative velocity of the contacting surfaces, μ is the traction coefficient, and Fₙₒᵣₘₐₗ is the force normal to the contacting surfaces. The normal force Fₙₒᵣₘₐₗ and the relative velocity v can be part of the dynamic-data 303. As described above, the power losses calculated from the traction coefficients 708 can be an input into building the thermal model at step 726.

In some examples, the thermal model that is built at step 726 is a lumped parameter thermal network model. The method can discretise such a model in several different ways, including:
a) Creating a lumped parameter thermal network, based on the parametric description, with one thermal node per component. However, this approach may not check whether the thermal model is suitable for the thermal analysis being carried out. The heat flux to and from a thermal node associated with a component can depend on the component's shape, size, material, heat capacity, and temperature compared to surrounding components. It may be that a model with one thermal node per component is unreasonably detailed, with a consequential penalty in analysis time, or that it is insufficiently detailed, meaning that the results may be insufficiently accurate. It is possible that the model may include details in one area that are excessive whilst missing necessary fidelity in other areas, leading to both slow computation and inaccuracy.
b) An alternative to the one-node-per-component discretisation of a lumped parameter thermal network described in a) above is manual discretisation, in which the user specifies the number of thermal nodes required for each component, or which components to lump together into a single thermal node. The method at step 726 can then build thermal model based on both user input and the parametric description 700. However, an engineer may need to spend time building and refining the model, and checking to see how the analysis results vary as the level of discretisation varies, for such manual discretisation. The engineer can aim to seek reassurance that the model is suitably accurate without being excessively detailed, but the process can be time-consuming and could end up being carried out by the most highly qualified and hence expensive engineer within the organisation, with resulting adverse impacts on project cost and timing.
c) Advantageously, an analytical formulation can be used to create a lumped parameter thermal network that is optimised for speed and accuracy of analysis. The method at step 726 can perform automatic discretisation of the model so as to retain thermal nodes at the points in the model that are appropriate for accurately describing the thermal behaviour of the driveline. As discussed above, the method can include power losses in the driveline in the lumped parameter thermal network as heat sources. The method can calculate values of thermal conductance and thermal capacitance for each component, using data from the parametric description of the driveline. From these values, the method can determine a ratio of thermal conductance to thermal capacitance for a component. The method can make this determination from information provided in the parametric description 700 such as material properties, and size and shape of the component. Alternatively, the ratio of thermal conductance to thermal capacitance may be directly available from the parametric description 700. The method can then compare the ratio of thermal conductance to thermal capacitance with one or more thermal-conductance-to-thermal-capacitance-ratio-threshold values. The method can advantageously model one or more of the driveline components as either a thermal conductance or a thermal node, depending on the ratio of thermal conductance to thermal capacitance. For instance, the method can model driveline components with a ratio that is higher than a thermal-conductance-to-thermal-capacitance-ratio-threshold value as thermal conductances. The method can model driveline components with a ratio that is lower than a thermal-conductance-to-thermal-capacitance-ratio-threshold value as thermal nodes. Thus the lumped parameter thermal network can be built and discretized automatically, without the need for manual input or modelling decisions from the user.

For example, consider a spacer separating two bearings mounted on the same shaft. The spacer is a thin-walled cylinder with very small mass. Its shape and position means that it conducts heat between the two bearings. Approach c) would employ the method of automatically determining whether to treat a component as a thermal mass or a thermal conductance based on the ratio of thermal conductance to thermal capacitance, and would therefore classify the spacer as a thermal conductance rather than a thermal node. This is appropriate because the thermal mass is negligible, but the effect of conducting heat between the bearings is significant, particularly if their temperature difference is high. Method a) would have classified the spacer as a thermal node, and method b) would have required an engineer to manually decide the most appropriate way to model that component.

The lumped parameter thermal model can be calculated for the whole driveline, including a gearbox and a motor if these components are present in the driveline. If the driveline includes power electronics, these can also be included in the lumped parameter thermal model as heat sources, with associated thermal conductances, as discussed above.

Time savings and error avoidance can be achieved by the automatic set up of the thermal inputs at components that have associated power losses. Also, as will be discussed below, heat flux values can be automatically determined at step 726 based on the operating conditions of the components.

Heat transfer can occur by different mechanisms including conduction, convection, and radiation. Conduction is straightforward, since thermal conductivity of solid metal components can be straightforward to calculate. For example, the method can calculate conduction heat transfer through bearings based on static analysis of the roller bearing and the contact area generated by the load dependent stiffness. Usually, heat transfer by radiation is small compared to conduction and convection. Heat transfer by convection, however, can be more difficult to determine. For example, the heat at a gear mesh is generated within the oil film and the heat transfer to the metal of the gear is determined by the convection Heat Transfer Coefficient (HTC) between the gear and the oil. These HTCs are difficult to predict with certainty. A hot metal surface sitting in still air will lose heat at a much slower rate than one experiencing gentle, laminar air flow over its surface, and even more so compared to one with rapid, turbulent air flow.

The thermal model built in step 726 can include values for HTCs associated with the driveline. These HTCs can relate to heat transfer between the internal driveline components and the lubricant, between the lubricant and the housing, and/or between the housing and the environment.

The values of HTCs can be determined in several ways, including:
i) The method can use default values for the HTCs.
ii) A user can provide input representative of HTC values to be used, which can involve the modifying of any default values.
iii) The method can automatically calculate the HTCs. The method can calculate convection HTCs using a Computation Fluid Dynamics (CFD) model, or using a simple lumped parameter thermal network model (described later in this document).

At step 728, the method calculates a temperature distribution 730 based on the thermal model that is built at step 726. For instance, at step 728, the method can calculate power losses for one or more of the components to determine an amount of heat that is generated at that component. Advantageously, the power losses can be calculated using the traction coefficients 708 from the tribology model run at step 706. The method can associate this amount of heat with the corresponding heat source in the thermal model. In order to determine the temperature distribution 730, step 728 may calculate heat flux in the driveline. In this way, the temperature distribution can comprise a temperature value associated with each of the modes in the thermal model. In some examples, the temperature distribution can include a plurality of temperature values for a single component.

The temperature distribution 730 can be used as an input to the tribology model. For example, the lubricant viscosity is a function of temperature. Advantageously, the temperature distribution enables the tribology model to calculate the traction coefficients 708 more accurately, since the effect of temperature on lubricant viscosity is accounted for.

Heat flux into the lumped parameter thermal network occurs wherever there is a power loss associated with any component. The values of these heat fluxes can be determined in several ways, including:
i) The values of these heat fluxes can be defined by the user, and these can be combined with the thermal model that was built at step 726 to perform thermal analysis 728 and calculate the temperature distribution 730 in the driveline.
ii) The method can automatically determine values of the heat fluxes. For example, the traction coefficients 708 can be used to calculate the power losses in the driveline, as described in Equation 2 above for the example of sliding friction. In other examples, when building the thermal model, the method may have performed known efficiency/power loss calculations for one or more components in the driveline to determine efficiency/power loss values. Then, when building the thermal model at step 726, the method can determine the values of associated heat fluxes based on the efficiency/power loss values as well as the parametric description 700. For instance, step 726 may process operating conditions from the parametric description 700 to determine the amount of energy at various components in the driveline.

The method can run thermal analyses at step 728 using a lumped parameter thermal network model, leading to values of the temperature being obtained at discrete thermal nodes. In other words, the term “lumped” is equivalent to the term “discretised”. If a thermal profile throughout the full structure is to be calculated, then a further thermal calculation can carried out based on the 3D structure of the driveline (as determined from the parametric description 700), based on the thermal properties of the driveline components. Thus, a smooth temperature profile can be obtained throughout all the mechanical components in the driveline.

The processing at step 728 can include application of Equation 3 below, which describes how to calculate heat flux in a thermal network model:

Q′=dT/R (Equation 3)

where Q′ is the heat flux (derivative of heat Q with respect to time), dT is the temperature difference, and R is the thermal resistance.

Thermal resistance R can be calculated in different ways for different components and heat transfer methods. For example, for convection heat transfer between a component and a fluid, R is given by Equation 4a:

R=1/hA (Equation 4a)

where h is the heat transfer coefficient and A is the contacting surface area. For conduction in solid components, Equation 4b describes how to calculate the thermal resistance:

R=L/kA (Equation 4b)

where L is the characteristic length, k is thermal conductivity, and A is the surface area. The parameter k is a material property, and the parameters A and L are geometric, all defined within the parametric description of the driveline. For conduction in bearings, the thermal resistance can be calculated using Equation 4c:

R=ln(r₀/r₁)/2πbk (Equation 4c)

where r₀ and r₁ are the inner and outer radii of the bearing, b is the face width, and k is the thermal conductivity.

The method can use Equations 3 and 4 at step 728 to calculate the heat fluxes between all nodes in the thermal model, and hence the temperature distribution 730 within the driveline.

Further details of how to set up and run a thermal network is provided in the thesis titled “Thermal modelling of an FZG test gearbox” by CARLOS PRAKASH DEL VALLE of KTH Industrial Engineering and Management Machine Design—in particular section 3.2.

The method of building a thermal model at step 726 based on a parametric description 700 and calculating a temperature distribution at step 728 can have several advantages:
1) The thermal model can encompass the entire driveline, including all components and sub-assemblies. This is an advantage over application-specific CAE tools, which consider only a specific component or sub-assembly in isolation.
2) As will be discussed below, the temperature distribution that is calculated based on the thermal model can be used to achieve a more accurate calculation of driveline deflections by including the effect of thermal expansion. Accurate deflections can be used to more accurately calculate efficiency, durability, and other performance metrics. This is an advantage over application-specific CAE tools, which calculate a temperature distribution but do not use it to improve the calculation of deflections.
3) The temperature distribution can be used to improve the accuracy of the traction coefficients 708 calculated by the tribology model, for example by ensuring that the lubricant viscosity accounts for temperature.

A lumped-parameter thermal network model can be created automatically and optimised for speed and accuracy, especially as described in approach c) above.

In this example, building the thermal model at step 726 also takes as an input the traction coefficients 708 calculated by the tribology model 706. That is, the process can calculate the temperature distribution 730 based on the thermal model and the traction coefficients.

Advantageously, use of the traction coefficients 708 at step 726 to build the thermal model can improve the accuracy of the thermal analysis at step 728, since power losses from friction at contacting surfaces can be used as heat sources in the thermal model.

In this example, the tribology model at step 702 receives the temperature distribution 730 as input data. For instance, at step 702, the method can create the tribology model of the driveline based on the parametric description 700 and the temperature distribution 730. At step 706 the process can calculate the one or more traction coefficients 708 using the tribology model that was built in step 702. Advantageously, use of the temperature distribution 730 can improve the accuracy of the tribology model 706, since the lubricant viscosity is a function of temperature. That is, a more accurate tribology model can be created by using the temperature distribution 730 as an input at step 702.

As discussed above, the traction coefficients 708 can also be used as an input into building the thermal model 726. Therefore, in some examples, feedback of the temperature distribution 730 into the tribology model 702 is provided alongside feedback of the traction coefficients 708 into the thermal model 726. In which case, the method may iteratively perform the processes for calculating the temperature distribution 730 and the traction coefficients 708 until any loop-end-conditions described herein are met. For example until the temperature distribution 730 and/or traction coefficient values 708 converge.

A limitation of generalist tools for driveline design is that thermal influences are not included accurately. However, often the key mechanical parts (shafts, bearings, gears, rotors, housings) of a driveline are made of metals that expand when heated, so the thermal influences can be important for structural and other types of analysis.

In some applications, it can be advantageous to know what the temperature distribution is within a sub-structure (for example, one or more of the components) of the driveline. As the driveline transmits power, friction generates heat at the gears and bearings. Also, as power is converted in electro-mechanical drivelines there are power losses in the electric machine and power electronics. The generated heat is typically removed to the environment, either through direct conduction through to the housing and thus the surroundings, or indirectly to oil, and from there either to the housing, or by extracting the oil to some form of radiator.

It has not been possible to accurately account for thermal influences in known tools for driveline design because, typically, different models are required for different tools, which require different data representative of the driveline. For example, a driveline can be modelled differently, with a different choice of discretisation nodes, for thermal and structural analysis. There can also be a technical difficulty of applying a temperature distribution to a mechanical model because the nodes can be in different places.

Simulation-led design of a driveline can be an essential tool for achieving a design that is fit for purpose. Examples described herein can advantageously predict thermal behaviour when performing modelling and design. For example, a temperature distribution can be calculated from a parametric description such that an accurate performance metric of the driveline can be determined. In turn, the performance metric can enable an improved design of the driveline to be generated. The improved design process can result in a driveline that is less likely to fail due to deflections caused by thermal effects. For instance, the determination of a more accurate temperature distribution in the driveline can enable a more accurate efficiency metric and more accurate values of deflections (described below), which in turn can result in more accurate durability metrics. In this way, the likelihood of early failure due to an underestimating of misalignment can be reduced.

The result is that thermal considerations cannot be included with sufficient accuracy in the practical design of drivelines using known CAE tools. Thus, drivelines are designed with sub-optimal performance and/or the risk that they will fail in test and development or, even worse, in operation. Indeed, such failures may not even appear as thermal failures—for example, it could be that the gear designer designed the micro-geometry of gears incorrectly (failing to account for thermal effects), leading to poor tooth contact, high stress, and premature but apparently-conventional fatigue failure.

Thermal performance is critically important in certain aerospace applications. It is a certification requirement of helicopter drivelines that they are able to operate for a certain period of time after the event of loss of lubrication, so as to ensure the safe delivery of the occupants in event of an emergency. However, such functionality is typically achieved through replicating the design features of previous designs followed by slow and very expensive testing of prototype units.

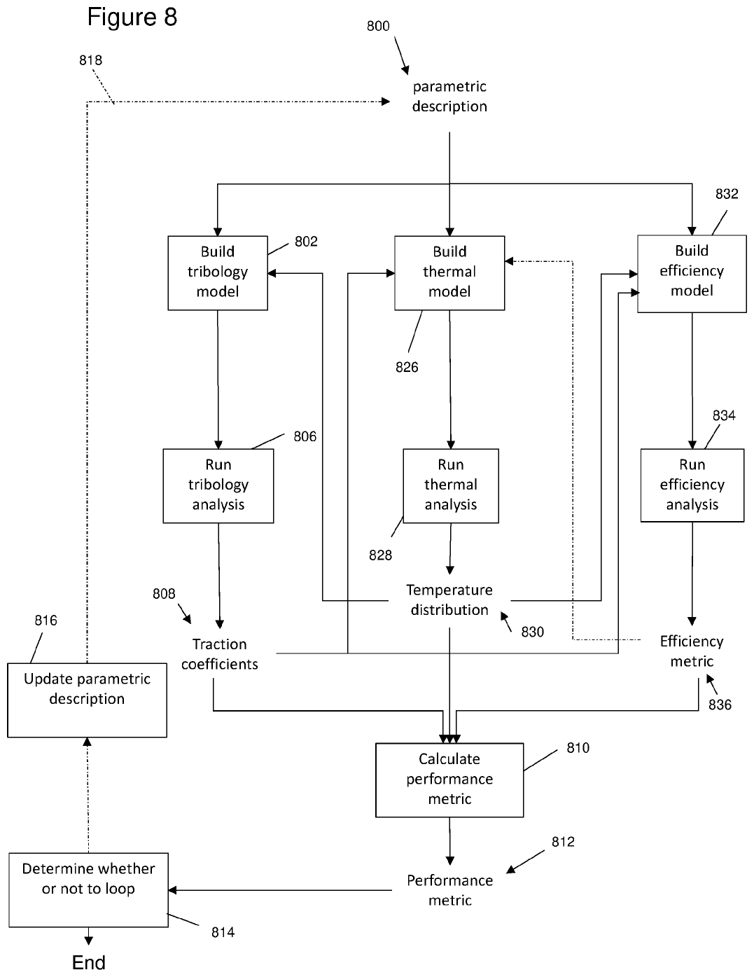

FIG. 8 shows a schematic view of a process for modelling a driveline, in which the tribology model 802 is combined with a thermal model 826 and an efficiency model 832. Since these models have been described relating to previous figures, only new features will be described here. Features of FIG. 8 that have corresponding features in an earlier figure will be given reference numbers in the 800 series and will not necessarily be described again here.

Advantageously, the temperature distribution 830 is used as an input to the tribology model 802. That is, at step 802, the method involves building a tribology model based on the parametric description 800 and also the temperature distribution 830 in the same way as described with reference to FIG. 7. The tribology model 802 can therefore include accurate values of lubricant viscosity, which is temperature-dependent.

In this example the process includes, at step 832, building an efficiency model based on the parametric description 800. Then, at step 834, the process runs efficiency analysis on the efficiency model that was built at step 832 to determine an efficiency metric 836.

The calculation of efficiency can be carried out using a range of different analytical methods for different drivetrain components. The main sources of power loss in a driveline can include gear mesh losses due to sliding friction between the gear teeth, gear churning losses due to splashing of the lubricant, and bearing losses. These power losses can be calculated using, for example, the methods defined in ISO standard 14179.

For example, the following standard methods for calculating gear mesh losses are commonly used:

1. A constant friction coefficient is assumed, and loaded tooth contact analysis is used to calculate the loads and local velocities on the gear teeth, and then the power loss is calculated as the traction coefficient multiplied by the load and the sliding velocity.

2. ISO 14179 calculates gear efficiency considering only the lubricant viscosity, not the frictional characteristics of the lubricant itself (which depend on which base oil(s) and additive(s) the lubricant contains). Lubricant friction characteristics can vary significantly, so the lack of consideration for lubricant properties is a major limitation of the standard. Therefore, an advantage of examples described herein that use the traction coefficients 808 in building the thermal model 826 and/or efficiency model 832 is that the lubricant characteristics are fully considered and therefore more accurate results can be obtained, including a more accurate performance metric 812.

An alternative to analytical methods for calculating gear mesh efficiency is to use actual test data in the efficiency calculation. For example, a mini traction machine (MTM) can measure the traction coefficients with a given lubricant. The test is easy to do, the machine is small and widely available, and can take measurements at different temperatures. The measured data (from an MTM) can be used with loads and relative velocities at contact points to calculate the power loss and related gear mesh efficiency. FVA 345 is one method of including lubricant data in the efficiency calculation, as described earlier.

In cases where the driveline includes an electric machine, the power losses of the electric machine can also be included in the efficiency model 832. The main sources of power loss in an electric machine can include copper losses due to electrical resistance in the machine windings, iron losses due to hysteresis and eddy currents, and mechanical losses due to bearing friction and windage. All of these can be calculated using standard analytical methods. The copper losses, iron losses, and mechanical losses are all dependent on temperature.

As shown in FIG. 8, in this example the efficiency model built at step 832 and analysed at step 834 determines the efficiency metric 836 also based on traction coefficients 808 that were calculated at step 806. As was described earlier, traction coefficients can be used to calculate power losses of components in the driveline. Equation 2 described how to calculate power loss from sliding friction using the traction coefficients 808. The power loss can be used as an input into both the efficiency model 832 and the thermal model 826 (as described earlier).

It is not feasible to use current CAE tools and current simulation methods to include the effects of traction coefficients on efficiency modelling and thermal modelling. This is because these different kinds of analysis are carried out in different CAE tools. Examples described in this document can have the advantage that the tribology analysis 806, thermal analysis 828, and efficiency analysis 836 are all carried out within the same CAE tool using data from the same parametric description 800 of the driveline. It is therefore much easier to use the outputs of one kind of analysis as an input into building a model for a different kind of analysis, without any of the time-consuming and error-prone transferring of data that would be required for separate analysis run in separate CAE tools.

Furthermore, in this example, the efficiency analysis at step 834 also uses the temperature distribution 830 that was calculated at step 828 to calculate the efficiency metric 836. Therefore, advantageously the efficiency metric 836 can account for the direct effects of the temperature distribution 830 on the efficiency directly. For example, the lubricant viscosity affects mechanical losses including gear mesh losses, gear churning losses, and bearing losses. Electric machine losses are also dependent on temperature, so using an accurate temperature distribution 830 as an input to the efficiency model 832 will advantageously result in more accurate efficiency metrics 836. Every contacting surface in a tribology model can be a heat source for the thermal model and a power loss for the efficiency model. Therefore, advantageously the processing described herein can build a tribology model and an efficiency model that have a corresponding structure (for instance at least some nodes that located at the same positions on the driveline). In this way, the results of analysis on one of the models can efficiently be combined with analysis using another type of model.

At step 828, the process can determine the temperature distribution 830 based on the thermal model that was built at step 826. Also, advantageously, the process can determine the temperature distribution 830 based on the traction coefficients 808. This was described in more detail earlier in relation to FIG. 7.

Optionally, the process can also build the thermal model at step 826 based on the efficiency metric 836. This can be advantageous because efficiency determines the power losses of components in the driveline, and these power losses are heat sources in the thermal model.

Optionally, any of the feedback arrows from the three analysis blocks 806, 828, 834 can be iterated until the output values converge. That is, one or more of the traction coefficients 808, temperature distribution 830, and the efficiency metric 836 can be recalculated until a loop-end-condition is satisfied. At step 810, the process can then calculate the performance metric 810 based on any or all of the traction coefficients 808, the temperature distribution 830, and the efficiency metric 836. In one example, the processing at step 810 can calculate a performance metric that corresponds to a power loss profile of the driveline. In some examples, the performance metric 812 may simply be one or more of the traction coefficients 808, the temperature distribution 830, and the efficiency metric 836. That is, the processing that is described with reference to steps 806, 828 and 834 may be considered as calculating a performance metric.

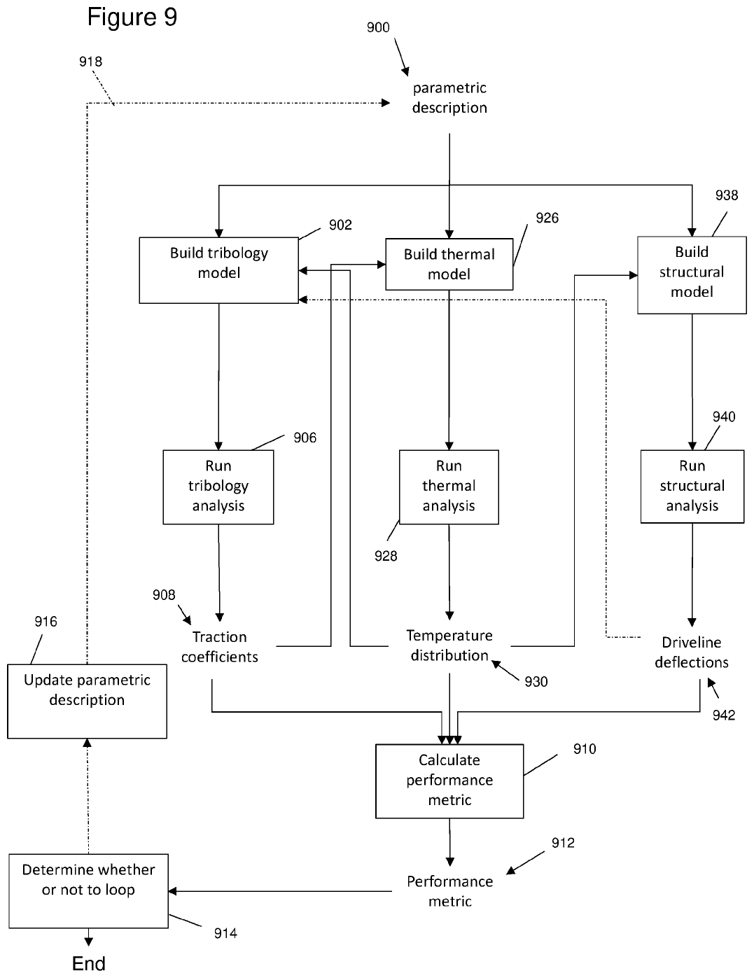

FIG. 9 illustrates a further embodiment of the invention, further including a structural model 938, which takes as an input the parametric description 900. Features of FIG. 9 that have corresponding features in an earlier figure will be given reference numbers in the 900 series and will not necessarily be described again here.

In this example, the process involves building a structural model of the driveline at step 938, based on the parametric description 900 and the temperature distribution 930. Then, at step 940, the process performs structural analysis 940 based on the structural model. The structural analysis 940 therefore calculates a deflection 942 of one or more components in the driveline. These deflections can include the effects of thermal expansion due to the temperature distribution 930, and structural deflections due to forces that occur in the driveline. Advantageously, at least the deflections 942 caused by thermal effects can be calculated particularly accurately because the temperature distribution is accurately calculated based on traction coefficients 908.

The structural analysis performed at step 940 can be a static analysis or a dynamic analysis, as will be described later. Advantageously, the temperature distribution 930 can be used as an input to the structural model 938 so the structural analysis 940 can take into account the thermal expansion of the driveline components, and include this in the calculation of deflections 942. The driveline deflections 942 can therefore include the effects of structural loading and thermal expansion.

At step 910, the process can then optionally calculate the performance metric 912 based on at least the calculated driveline deflections 942.

Optionally, at step 902, the process can build the tribology model based on the calculated driveline deflections 942. In this way, more accurate dynamic-data, such as speeds and pressures at contacting surfaces, can be calculated for the tribology model 902. Accounting for deflections can be advantageous because they affect the size and shape of the contact areas between contacting components, as well as the contact pressures.

Examples of a performance metric 912 that can be calculated at step 910 include misalignment between different parts of components in the driveline, durability, and transmission error. In some examples, the performance metric 912 can be a representation of the calculated deflection.

Turning now to the structural analysis that is performed at step 940 in more details. At step 940, the method can calculate deflection for every node in the structural model of the driveline. Deflections can include the effects of structural forces in the driveline and the effects of thermal expansion.

The method can calculate deflections caused by thermal expansion using Equation 5:

dX=alpha*X*dT (Equation 5)

where:
dX is the deflection,
alpha is a dimensionless thermal expansion coefficient (a material property that can be included in the parametric description 900),
X is the original position of the node (which can be included in the parametric description 900, or determined from the parametric description 900 by the method building a structural model of the driveline). X can be provided as a vector that defines the positions and rotations of every node, in three dimensions, in the structural model. Therefore, the position of each node can be defined in six degrees of freedom, and
dT is the change in temperature, as determined from the temperature distribution 930 that is calculated at step 928. dT can be the difference between the node's temperature and a defined temperature (usually 25° C.), such that the material expands if T>25° C. and contracts if T<25° C.

At step 940, the method can calculate deflections caused by forces that occur in the driveline. Such deflections can be considered as being caused by structural forces. In some examples, the deflections can be calculated by i) static analysis, or ii) dynamic analysis of the driveline system. The driveline system can be considered as all of the nodes in the complete driveline. These methods are described in more detail below.
i) Static analysis resolves the applied forces on all components of the driveline to calculate deflections, taking into account that some component stiffnesses may be load-dependent. Therefore the method needs to iterate over the forces, deflections, and stiffnesses until convergence is achieved. The method assumes that forces and displacements are not time-varying, other than rotating at a constant speed as specified in operating conditions that are provided as part of the parametric description 900.
ii) Dynamic analysis, in contrast to static analysis, permits the deflections and applied forces to vary with time. This allows time-varying excitations to be included in the analysis. Time-varying excitations can include transmission error, engine torque ripple, electric machine torque ripple, and electric machine radial forces. In dynamic analysis the deflections can be determined by solving the driveline system's equation of motion, represented in a matrix formulation in Equation 6:

MX″+CX′+KX=F (Equation 6)

where:
M is the driveline system mass matrix (which can be included in the parametric description 900, or derived therefrom),

C is the driveline system damping matrix (which can be included in the parametric description 900, or derived therefrom),

K is the driveline system stiffness matrix (which can be included in the parametric description 900, or derived therefrom),

F is the applied force (which can be included in the parametric description 900, or derived therefrom, for example from “operating conditions” stored in the parametric description 900), and the vector X defines the positions and rotations of every node in the structural model in six degrees of freedom, in the same way as described above for Equation 5. The notation X′ means the derivative of X with respect to time.

The structural model can be solved either statically or dynamically, as described above. Both of these methods calculate the deflections in six degrees-of-freedom for every node in the driveline structural model.

The method can solve the matrix equation for X to determine the new positions and rotations of the nodes in the structural model. Deflections can be considered as the difference between new position/rotation values and starting position/rotation values of the nodes.

In examples where step 940 calculates deflections of nodes due to both thermal effects and structural effects, the method can combine these deflections into an overall-deflection-value. For example, the method can simply sum the individual deflection values together.

For driveline components that are bearings, the method can calculate deflections 942 using an alternative method of applying the temperature distribution 930 to the structural model. The structural model can include nodes that correspond to one or more of the inner raceway, outer raceway, rotating elements, and connected components. At step 938, the method can apply the temperature distribution 930 to determine temperature values at these nodes of the structural model. Then, when running the structural analysis at step 940, the method can determine a thermal expansion at these nodes, and determine how that expansion alters the operating clearance of the bearing. The operating clearance can therefore be different from the radial internal clearance, which is a standard value from the bearing manufacturer. The operating clearance is an example of a representation of a deflection 942, which can be used to determine a more accurate performance metric 912.

CAE tools can be used to calculate transmission error (TE) by running the gear through a mesh cycle and calculating the variation in mesh stiffness. Transmission error is the deviation of the rotation angle from the nominal value. In examples where the structural analysis is a dynamic analysis rather than a static analysis, the resulting TE can be used as an excitation to the driveline structure, leading to a forced response analysis and prediction of the vibration at the surface of the housing and, if required, a prediction of radiated noise. This process can be set up specifically for gears and drivelines. The model can be parametric and fast to run, and the post processing can be set up in the form of accessible graphical user interfaces.

In addition to TE, other excitations in the driveline can be applied, including engine torque ripple, electric machine torque ripple, and electric machine radial forces. In examples where the structural model is solved dynamically, these excitations will be included in the applied force vector F in Equation 6.

In all of the potential failure modes and the corresponding calculations thereof, one key influencing factor is misalignment. Misalignment can be caused by components deflecting such that their position, or at least a position of part of the component, relative to another component changes. Within a rolling element bearing, misalignment can increase the stress for each fatigue cycle and reduce bearing life. For gears, misalignment can increase the contact pressure between the mating teeth, which reduces resistance to fatigue and increases the likelihood of scuffing. Misalignment can also alter the contact patch between contacting gears, thereby increasing TE and affecting the oil film between the gears, thereby increasing gear mesh power loss and reducing overall driveline efficiency.

It can be advantageous to calculate the deflection of one or more components of the driveline. As indicated above, such deflections can result in misalignment of gears and bearings under operating conditions, as one example. To calculate such deflections/misalignments of gears and bearings, the structural model 938 can be a mathematical representation of the full gearbox sub-system, consisting of shafts, bearings and gears, can be used. Gear forces are generated at the gear meshes due to applied torque, leading to shaft deflections, load-dependent deflection of the bearings, and housing distortion. The result, both in practice and in calculation, is a misalignment of the gears and bearings as the gearbox transmits power, which affects the aforementioned failure modes/performance targets of gear fatigue, scuffing, TE, efficiency, and bearing fatigue.

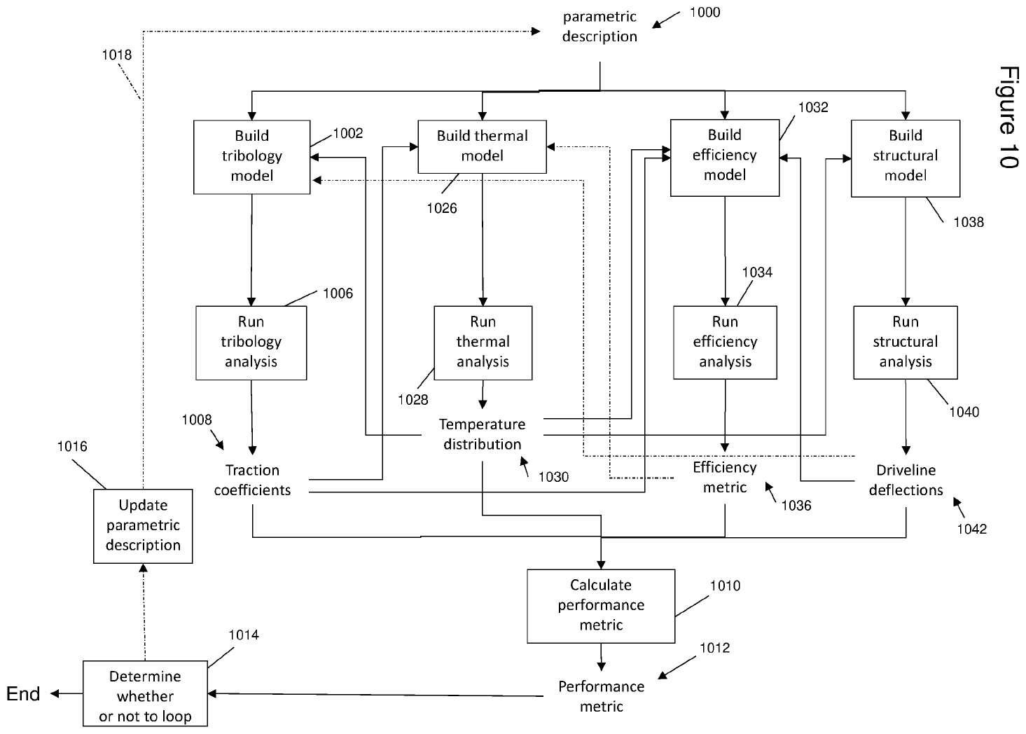

FIG. 10 illustrates a driveline modelling method which combines tribology, thermal modelling, efficiency, and structural modelling into one integrated process. This figure brings together all of the interactions between different models already described. Features of FIG. 10 that have corresponding features in an earlier figure will be given reference numbers in the 1000 series and will not necessarily be described again here.

In this example:
Building the tribology model at step 1002 is based on the parametric description 1000 and one or more of: dynamic-data (derived from the parametric description 1000), the temperature distribution 1030, and the driveline deflections 1042;
Building the thermal model at step 1026 is based on the parametric description 1000 and one or both of: the efficiency metric 1036, and the traction coefficients 1008;
Building the efficiency model at step 1032 is based on the parametric description 1000 and one or more of: the driveline deflections 1042, the temperature distribution 1030, and the traction coefficients 1008;
Building the structural model at step 1038 is based on the parametric description 1000 and optionally also on the temperature distribution 1030; and
Calculating the performance metric 1012 at step 1010 can be based on any or all of the traction coefficients 1008, the temperature distribution 1030, the efficiency metric 1036, and the driveline deflections 1042.

The invention uses the same driveline definition throughout, based on the parametric description. This makes it possible to apply outputs of one analysis as an input into building a model for a different type of analysis. This would not be possible with separate CAE tools, because the results for each kind of analysis would be defined differently, in different CAE tools, applied in different positions on the driveline, provided to different levels of fidelity, and differently discretised. A single driveline definition within a single CAE tool enables the interaction of the models representing different types of physics, and results in performance metrics that are more accurate, since all relevant influences are considered. For example, the thermal model can easily be set up to use the same mesh as the structural model, so the temperature distribution resulting from the thermal analysis can be directly applied to the structural model, with a temperature value defined for each node in the mesh. The tribology model can define the locations of all contacting surfaces in the driveline, and then the traction coefficients calculated at these locations can be applied directly to the efficiency model, which calculates power losses at each of these locations using the traction coefficients. The power losses can be applied as heat sources in the thermal model, again at the same set of locations in the driveline. This would not be possible if each type of analysis (tribology, thermal, structural, efficiency) had its own driveline model with different geometry definitions, different discretisation, and analysis results calculated at different locations. That is, in some examples, the process can build a plurality of models for different types of analysis (such as tribology analysis, thermal analysis, structural analysis, efficiency analysis, dynamic analysis, and any other type of analysis that can be used calculate a performance metric), such that the different models have a common structure. For instance, the models may have one or more of: (i) common node positions, (ii) a common level of fidelity, (iii) the same mesh, and (iv) be discretised in the same way. In this way, the different models can be built in such a way that they can be efficiently used together by processes described herein. In at least some instances, this may be contrary to skilled person's expectations of building a model in a particular way, for a single type of analysis that is not expected to be combined with another type of analysis from a separate CAE tool.

The interactions between the different models described in FIG. 10 can be very valuable in designing a better driveline. A design change in the parametric description 1000 can affect any of the performance metrics calculated by different analysis types. Given the many ways in which the different analysis types interact, it can be beneficial to consider thermal/efficiency/tribology/structural models together in order to capture all interactions and get an even more accurate result.

For example, loads on bearings, bearing misalignments, and bearing ring distortion are all calculated from the driveline system deflections. The deflections are calculated by the structural model, accounting for gear loads, non-linear bearing stiffness, and non-uniform temperature distribution, hence relying on the outputs of the thermal model. The load-sharing between the rolling elements in each roller bearing plus the contact pressure distribution between each rolling element and the raceways is calculated. Contact pressure can be an input into the tribology model as part of the dynamic-data (as described above with reference to FIG. 5).

These values of bearing misalignment, bearing ring distortion and bearing contact pressure distribution can be used to calculate the contact forces between subcomponents within the bearing. The traction coefficients calculated by the tribology model, along with these contact forces, can be used by the efficiency model to calculate the bearing drag and power loss. Lubricant properties can be included in the tribology model, and lubricant viscosity can be affected by the lubricant temperature, provided as an output of the thermal model. The bearing power losses of the efficiency model can then be used as an input to the thermal model as heat sources.

The calculation of the impact of lubricant on bearings described above can be carried out alongside a calculation of gear mesh efficiency including detailed lubricant definition. Traction models such as FVA 345 can include the effects of lubricant formulation and additives, by using coefficients obtained from testing. A substantial interaction between the design of the bearings, design of the gears and design of the lubricant can then take place at different levels.

Gear design is another example where the interaction between the different models is valuable. The gear macro-geometry determines the gear forces within the driveline for given operating conditions, and the gear forces impact upon the bearing loads, misalignments, contact pressure between the rolling elements and the raceways, and hence the interaction with the lubricant, and the impact of the lubricant on bearing drag.

Gear macro-geometry also affects gear mesh efficiency, and hence the power loss mechanism at the gears. Design choices in the gear macro-geometry can sometimes result in an advantageous effect on one performance metric but a disadvantageous effect on another performance metric. For example, increasing the working pressure angle of a gear increases the efficiency of the gear mesh but puts more load on the bearing. Increased bearing load may increase the bearing drag, an effect which can be investigated and understood using the tribology model. A design change in the gear macro-geometry will have an impact upon gear durability, gear transmission error, gear efficiency and bearing drag. The impact on the last two requires a detailed assessment of the oil properties that goes beyond standard efficiency methods such as ISO 14179. Design changes, such as to the oil formulation and/or gear macro-geometry, need to be assessed with regard to a multiplicity of performance criteria. This invention considers the interaction of different types of analysis and facilitates the consideration of multiple performance metrics in gear macro-geometry design.

As gears pass through the mesh cycle, the stiffness of the mesh varies, causing a phenomenon known as transmission error (TE). This variation in stiffness acts as an excitation which is tonal in nature and can excite the driveline structure and lead to gear whine, an annoying noise which is unpleasant to the human ear and unacceptable in a consumer product such as a passenger car. Gear micro-geometry impacts on gear transmission error, as well as the gear mesh efficiency. A designer may choose to improve the driveline efficiency through modifications to the micro-geometry or changes to the oil specification, the latter of which will affect bearing drag. The structural model can be solved dynamically, so that the dynamic response of the whole driveline to transmission error and other excitations can be calculated, thereby allowing the designer to understand all the knock-on influences of any design change across a range of different performance criteria.

In one embodiment the invention uses efficiency calculations including lubricant test data (for example, the FVA 345 method) combined with system deflections and loaded tooth contact analysis (LTCA). LTCA can be included in the structural model of the driveline. System deflections are dependent on shaft deflections, housing deflections, and non-linear bearing deflections. LTCA is a method for analysing the physics of contact between meshing gear teeth, accounting for deflection of the parts of the tooth flank that are in contact, and calculating the stress distribution on the gear tooth flank. The load is dependent on system deflections and micro-geometry, and affects the gear durability and transmission error. Thus, a design change in the gear tooth micro-geometry affects noise, durability and efficiency if system deflections are included, but in some applications the effects can only be adequately modelled if the calculations correctly account for lubricant properties. Including lubricant properties in the efficiency calculation can be achieved by, for example, the FVA 345 method. Non-linear bearing stiffness affects the system deflections and misalignments, which affect the shape of the contact patch between meshing gear teeth, and therefore affect durability/efficiency/noise.

Besides noise due to gear whine, other dynamic simulations can be used to check that a driveline is fit for purpose. The change of gear (or speed) ratio often involves the engagement of a clutch or synchroniser, and this discontinuous change in the speed/gear ratio of the driveline creates a transient shock which, for the purposes of passenger comfort, driveline designers wish to minimise.

The study of these speed ratio changes involves time stepping through a speed change event, calculating the forces, torques and velocities at each time step. Frictional forces in the clutch or synchroniser are calculated as the clutch or synchroniser is engaged.

These methods are typically carried out in MBD packages (Adams, Simpack) or multi-domain simulation packages (Simulink). Some application-specific CAE tools talk of being able to carry out this simulation.

For many years it has been accepted engineering practice to select lubricants with very different properties for an automatic transmission as opposed to a manual transmission. “ATF” (automatic transmission fluid) is designed to allow the clutches and brakes to engage consistently so as to achieve a smooth gear shift.

The reality of the engineering design process is that the impact of this lubricant selection on the rest of the components was not always well understood and was certainly not quantified. A fluid may be selected for its frictional properties which would give an improved shift performance, and this would be studied through simulation in a MBD tool such as Adams, a multi-domain simulation tool such as Simulink or an application-specific CAE tool such as Driva, but the representation of the friction is in the definition of a simple coefficient of friction, and is not speed, load or temperature dependent. Furthermore, the detailed impact of the lubricant selection on the gears and bearings is not considered, for reasons described previously.

Examples described herein can advantageously provide further dynamic analysis including the impact of lubricant in the form of the simulation of clutch engagement. The event of a clutch engagement is to simulate the change in gear speed/ratio and the aim is to understand the comfort of this event for the passengers of, for example, a passenger car.

The simulation consists of a transient dynamic simulation through the shift event, with the clutch/synchroniser torque being calculated as a function of the friction. The coefficient of friction could either be a constant value or could be calculated using similar traction models to those used for bearings, which a combination of traction models consisting of boundary lubrication, elasto-hydrodynamic lubrication and mixed lubrication.

The key advantage is that now the selection of a given lubricant can be interpreted in light of the influence on the shift quality of the gearbox, the efficiency of the driveline and the durability and wear of the gears and bearings. Good clutch engagement requires specific frictional behaviour, especially at low speeds. This frictional behaviour may be disadvantageous to the performance of gears and bearings, and the resulting trade off in performance can be investigated.

All simulation methods can take a definition of the component geometries and properties, operating conditions and load cases as inputs. A single value for each of these yields a single result for the performance assessment. However, in reality all of these inputs are subject to variation. To understand the real life operating performance of the population of gearboxes from a production line, it is necessary to vary the input parameters in line with production tolerances.

All of the simulations described thus far use input values based on a parametric description of the driveline with the parameters set to their nominal values. It is very important to investigate how engineering systems perform as parameter values vary from the nominal, based on manufacturing tolerances, environmental variation or degradation. The invention provides the facility to apply tolerances to the parametric definition of the driveline in order to understand the behaviour of all manufactured drivelines in all operating and environmental conditions.

All of these simulations provide the design engineer with the possibility to design drivelines that are more efficient, more durable and with better gear shift quality, at the same time as not compromising noise performance. All of this is achieved in a way that minimises the cost of design and development and which minimises the risk of failure in test or in-service use.

In summary, a plurality of analysis types (such as, but not limited to: tribology, efficiency, structural, and thermal) can be used simultaneously in modelling and designing drivelines. Interactions between the different analysis types and between different components in the driveline can therefore be accounted for. The result of this integrated analysis is more accurate performance metrics, ultimately leading to a better driveline design and/or a more accurately modelled driveline.

Examples described herein can also allow the simulation of bearing performance in those operating conditions where dynamic influences become important, for example, wind turbine bearings with rollers with large inertia, and high speed bearings in aerospace, electric motor and machine tool spindle applications where gyroscopic and centrifugal effects become significant.

An additional failure mode for rolling element bearings is skidding. In an ideal situation, kinematics of the rolling elements means that their motion at the contacting interface with the inner and outer races is pure rolling.

In this instance, there is minimum friction (hence power loss and thermal heating) and minimum wear (hence maximum durability). Skidding describes the behaviour where the motion at the contacting interface involves either spinning (rotating about a point) or sliding (translation). In this instance, the friction at the contacting surface generates heat, which causes power loss. The heat also causes a localised reduction in the lubricant viscosity, which reduces the oil film and can cause metal-metal contact, leading to wear and premature failure.

This non-ideal motion at the contacting surface can be caused by a number of factors, which vary according to application. For example, in wind turbines and other large machinery, the shafts rotate relatively slowly and the supporting bearings are large, with large rollers. Through each rotation of the bearing, a roller experiences a loaded zone and an unloaded zone. Within the loaded zone, it is squeezed between the inner and outer races, and relative rotation between these two races, along with traction forces at the roller-raceway contact, imparts rotational motion of the roller around its own axis and the roller achieves rolling motion at the contacting interfaces. As the roller moves to the unloaded zone, drag causes the rotational motion of the roller to slow and there are no loads on the inner and outer races to maintain rotation. The result is that as the roller re-enters the loaded zone and is squeezed by the raceways, the roller rotational speed is below that required for pure rolling motion. Sliding motion between the raceways and the roller leads to friction, metal-metal contact, wear and premature failure.

In high speed machinery such as aerospace engines and gearboxes, high speed motors, turbo chargers and machine tool spindles, it is the high speed that causes problems. A combination of axial and radial forces on a ball bearing means that the axis of rotation of each ball must change through each rotation of the bearing if ideal, rolling motion is to be achieved. However, Coriolis forces aim to maintain the axis of rotation of each ball, meaning that pure rolling behaviour is not achieved.

In summary, bearing skidding happens when the tractive forces between the rolling elements and the raceways of a bearing are not sufficient to overcome drag and inertial forces. The result is that the rolling element slides against the raceway, rather than rolling. Skidding is a problem because the sliding contact can generate excessive heat, and the high shear stress can cause wear and premature bearing failure. In order to prevent skidding, a minimum load must be applied on the bearing.

Current bearing drag models such as ISO 14179 omit some important influences. As radial internal clearance, axial:radial force ratio, misalignment and raceway deflections change, the load distribution among the rollers change, affecting the contact pressure between the rolling elements and the raceways, and hence the friction. Indeed, misalignment of the bearings means that true rolling motion is not possible at a microscopic level. ISO 14179 does not account for this.

Application-specific CAE tools treat the bearing as in the “quasi-static” form, meaning that although the rollers are known to be rotating and incurring fatigue cycles, the inertial forces are mostly ignored and the true dynamic behaviour of the bearing is not considered. Thus, bearing skidding, which leads on to wear, cannot be predicted for those applications where bearing roller inertial behaviour is important, such as wind turbine gearboxes, and bearings for high speed shafts (aerospace, high speed machine tools, electric motors, turbochargers).

Some application-specific CAE tools such as Adore do consider the inertial effects of the rolling elements, and carry out a time stepping analysis in order to try to predict skidding. However, in these packages only the bearing is modelled and no account is made of the rest of the system (shaft, housing, gear, non-uniform temperature distribution) which has such a profound effect on the bearing in the form of misalignment and varying axial:radial load. In addition, the bearing raceways are always assumed to be circular, so no account is made of their flexibility.

In predicting skidding, these application-specific CAE tools use a time stepping, numerical process, where the forces at a given time step are used to calculate accelerations, velocities, new displacements and on to new forces for the next time step. This has to be carried out for every element of interest in the bearing system and the smaller the time step, the greater the accuracy. This provides several problems. No matter how small the time step is made, there is still an error as all the conditions are assumed to be constant within a time step. Also, it is very slow, with some simulations taking several hours or a few days just for one speed/load condition. This means that completing a full survey of the behaviour of a bearing in all operating conditions is very time consuming, and a design-analysis-redesign iteration to improve performance is effectively impractical.

Prediction of skidding does not necessarily mean that damage to the bearing will occur. Skidding is only a problem if the resulting localised heating of the lubricant and reduction in film thickness leads to surface wear or damage. The latter (wear) is dependent on the former (skidding), but it is only skidding that is predicted.

Various skidding models exist which can calculate the value of this minimum load for given operating conditions. However, most of these models are quasi-static and are limited to axially-loaded bearings and constant speeds. In practice, bearings operate under combined axial and radial loads, and time-varying speeds. In particular, wind turbine bearings are susceptible to skidding, as they tend to operate at high speeds and low loads.

For examples described herein, load-sharing among the rolling elements, contact condition with the raceways, raceway deflection, misalignment and axial:radial force distribution can all be calculated within the context of a mathematical model of the full driveline system, including gear forces, shaft deflections, housing deflections, non-linear bearing stiffness and non-uniform temperature distribution. The contact conditions with the raceways can then be used in calculating the traction forces between the rollers and the raceways using a lubrication model that consists of boundary lubrication, elasto-hydrodynamic lubrication and mixed lubrication, making use of the traction model.

The model can predict the skidding of each roller at each position as the roller proceeds around the roller bearing. Furthermore, it can use this prediction of skidding to predict the reduction in viscosity of the oil, the reduction in film thickness and the onset of wear caused by the skidding.

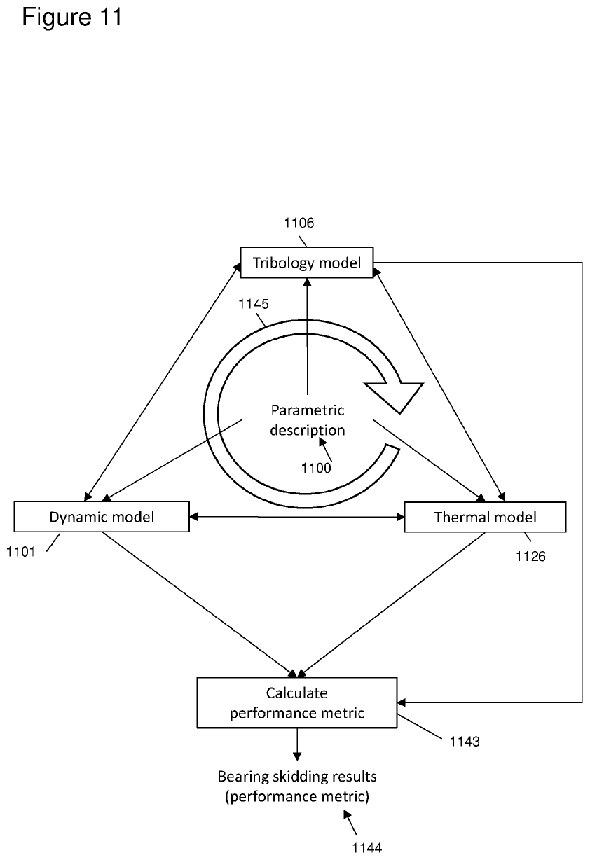

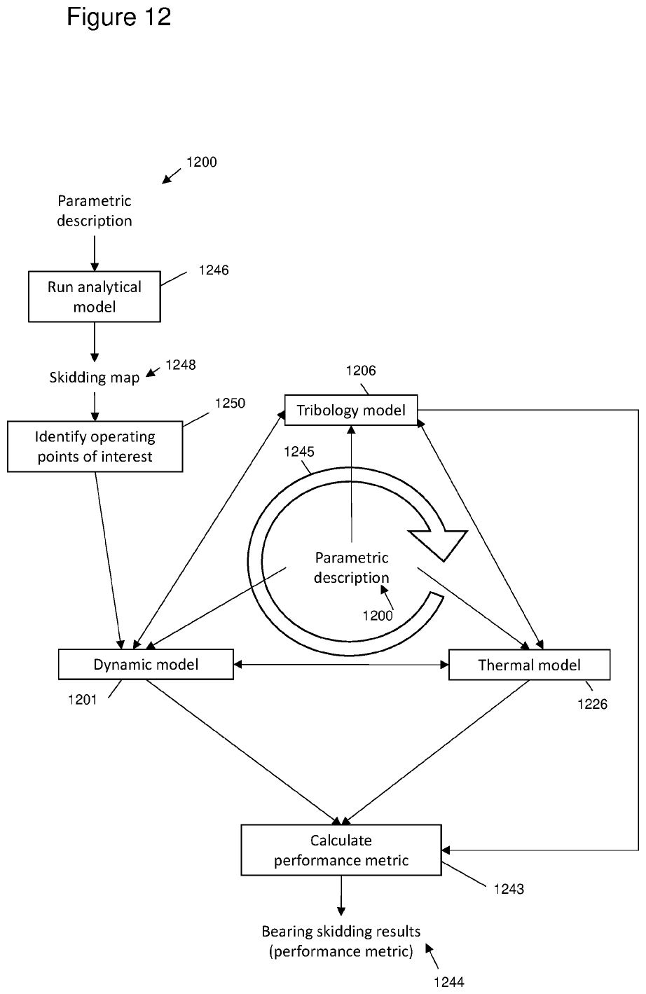

Skidding prediction can be carried out in several ways: a) numerical analysis (described with reference to FIG. 11), and b) a combined numerical analysis and analytical approach together (described with reference to FIG. 12). In at least some applications, using an analytical approach on its own (i.e. without numerical analysis) may not be sufficiently accurate.

FIG. 11 shows a schematic view of a process for modelling a driveline. This process can be considered as a numerical analysis for determining bearing skidding results 1144 (which is an example of a performance metric). As will be discussed below, the process involves a time stepping analysis of the forces, accelerations, velocities and displacements at each time step. This represents an accurate solution, but can be time consuming.

As in previous flowcharts, the parametric description 1100 of FIG. 11 is used as an input to a dynamic model processing block 1101. The dynamic model processing block 1101 can build and run a dynamic model in the same way as described above. The dynamic-data can be representative of contact operating conditions such as the speeds and pressures at contacting surfaces in the driveline. A tribology model processing block 1106 can build and run a tribology model in the same way as described above, based on at least the parametric description 1100, in order to determine traction coefficients. A thermal model processing block 1126 can build and run a thermal model in the same way as described above, based on at least the parametric description 1100, in order to determine a temperature distribution.

In this example:
The tribology model processing block 1106 can calculate the traction coefficients based on one or both of the temperature distribution and the dynamic-data, as represented by the arrows pointing towards the tribology model processing block 1106 in FIG. 11.
The thermal model processing block 1126 can calculate the temperature distribution based on one or both of the traction coefficients and the dynamic-data, as represented by the arrows pointing towards the thermal model processing block 1126 in FIG. 11.
The dynamic model processing block 1101 can calculate the dynamic-data based on one or both of the temperature distribution and the traction coefficients, as represented by the arrows pointing towards the dynamic model processing block 1101 in FIG. 11.

The three model processing blocks 1106, 1101, and 1126 can be interdependent, each taking as inputs the outputs of the other two models. The process can run the models iteratively, repeating until convergence is achieved in one or more of the traction coefficients, the temperature distribution and the dynamic-data. This can be considered as a convergence loop, shown schematically in FIG. 11 with reference 1145, whereby each model is run in turn until one or more of the results of running the model is sufficiently settled such that the loop can be ended. As above any loop-end-condition can be used by the process to determine when to stop going around the convergence loop 1145.

At step 1143, the process can calculate the bearing skidding results 1144 based on the parametric description 1100, and one or more of: (i) the dynamic-data (from the dynamic model processing block 1101), (ii) the temperature distribution (from the thermal model processing block 1126), and (iii) the traction coefficients (from the tribology model processing block 1106). In this way, the bearing skidding results 1144, an example of a performance metric, can be calculated based on any or all of the three models 1106, 1102, and 1126, depending on the user's requirements for reporting of the results. The bearing skidding results can include traction coefficients, temperatures, power losses, durability metrics, and other parameters.

In addition to the convergence loop 1145, the method of FIG. 11 can be used as a time-stepping numerical model. The outputs of the three models 1106, 1102, and 1126 at one timestep in the simulation can be used as initial conditions for the next timestep in the simulation. For example, the temperature distribution calculated by the thermal model 1126, after reaching a convergent value at one timestep, can be used as the initial temperature distribution for the first iteration in the next timestep.

FIG. 12 shows a schematic view of another process for modelling a driveline. This process can be considered as a combination of: (i) the numerical analysis that was described above with reference to FIG. 11, and (ii) an analytical solution that will be described below, in order to determine bearing skidding results 1244 (which is an example of a performance metric). Features of FIG. 12 that have corresponding features in an earlier figure will be given reference numbers in the 1200 series and will not necessarily be described again here.

The analytical approach described below is used to identify conditions where skidding is likely, and also to investigate possible solutions. The results from the analytical approach indicate the conditions where it would be productive to run the slower numerical solution (as provided by the loop between model running steps 1206, 1201, 1226). This can avoid the problem of estimating a likely skidding condition and running a simulation lasting days only to find that no skidding occurs. The numerical approach can then be used to confirm this result and understand the severity of skidding.

In FIG. 12, at step 1246 an analytical model of at least one bearing is built and run based on the parametric description 1200. The processing at step 1246 can apply an analytical solution that can be written in closed form equations that predict the onset of skidding. This can be much quicker than the numerical analysis; it can be able to create a skidding “map” 1248 in a matter of seconds as opposed to hours or days. It can be a less accurate approach that the numerical analysis of FIG. 11, but can still be useful as an initial processing step before performing the numerical analysis of FIG. 11.

For bearings under constant axial loads and constant speeds, the minimum load required to prevent skidding is given by Equations 7a:

$${\int }_{- a}^{a} {\int }_{- b}^{b} η ( {x}^{a} , {y}^{a} ) {dx}^{a} {dy}^{a} \geq \frac{π {hC}_{D} {ρ ( {ω}_{c}^{th} {r}_{p} )}^{2} {r}^{2}}{4 Δ {u}_{max}} \\ and \\ {\int }_{- a}^{a} {\int }_{- b}^{b} η ( {x}^{a} , {y}^{a} ) {dx}^{a} {dy}^{a} \geq \frac{{G}_{0} h}{Δ {u}_{max}} . \qquad ( Equation 7 a )$$

where η is lubricant viscosity, x″y″z″ is a moving coordinate system with x″ and y″ axes lying in the plane of the contact-patch and z″ axis parallel to the contact line, a and b are the extents of the elliptical contact patch, h is the lubricant film thickness, C_{D} is the drag coefficient, ρ is the lubricant density, ω_{c}^{th} is the theoretical value of cage speed, rₚ is the pitch radius, r is the rolling element radius, Δuₘₐₓ is the maximum permissible slip speed, and Go is the gyroscopic force.

For bearings under combined axial and radial loads, the extent of skidding inside the load zone is given by Equation 7b:

$$\vert - {θ}^{3} + \frac{3}{2} {θ}_{L} {ϑ}^{2} \vert \geq \frac{3 I {ω}_{b}^{th} {ω}_{a}^{th} {tan}^{2} {βθ}_{L}^{2}}{8 r {μ}_{AB} {F}_{e}^{max}} \\ and \vert \frac{3}{2} {θ}_{L} {Θ}^{2} - {Θ}^{3} + {ϑ}^{3} - \frac{3}{2} {θ}_{L} {ϑ}^{2} \vert \geq \frac{π abI {ω}_{b}^{th} {ω}_{c}^{th} {θ}_{L}^{2} tan β}{4 {μ}_{BC} {F}_{e}^{max} Φ ( a , b )} , \\ where Φ ( a , b ) = {\int }_{- a}^{a} {\int }_{- b}^{b} \sqrt{1 - {( \frac{x}{b} )}^{2} - {( \frac{y}{a} )}^{2}} \sqrt{{x}^{2} + {y}^{2}} dxdy , \qquad ( Equation 7 b )$$

where θ is the angular extent of the sliding-contact region, θ_{L} is the angular extent of the load zone, I is the moment of inertia of a rolling element, ω_{b}^{th} and ω_{c}^{th} are the theoretical values of cage and element speeds, β is the contact angle between element and raceway, μ_{AB} is the coefficient of friction acting between rolling elements and raceways in the sliding contact region, Fₑ^{max} is the maximum contact force acting on a rolling element inside the load zone, Θ is the total angular extent of the skidding region (sliding-contact region+spin-contact region), and μ_{BC} is the coefficient of friction acting between rolling elements and raceways in the spin-contact region.

For bearings under constant axial loads and varying speeds, skidding occurs if the speed fluctuations are greater than a threshold given by Equation 7c:

$$ΩΔω \leq \frac{2 {μ}_{e} {F}_{a} ( {r}_{i} + {r}_{a} )}{{zI}_{c}^{2} sin β ( 1 - \frac{cos β}{{r}_{p} \text{/} r} )} - \frac{{C}_{B}}{4 {F}_{a}} πρ {r}_{p}^{2} {r}^{2} {ω}_{B}^{2} ( 1 - \frac{cos β}{{r}_{p} \text{/} r} ) . \qquad ( Equation 7 c )$$

where ω and Δω are the frequency and amplitude of speed fluctuations, μₑ is the friction coefficient between an element and the raceway, Fₐ is axial load, rᵢ and r₀ are the radii of the inner and outer race, z is the number of rolling elements, I_{c} is the moment of inertia of a rolling element about the bearing axis, and ω₀ is the mean speed.

All of the information necessary to apply each of Equations 7a-7c can be available from the parametric description 1200, either directly or indirectly. An example of indirectly available information is the dynamic-data described above.

In this way, the output of processing step 1246 is a skidding map 1248 which defines which operating regions are susceptible to bearing skidding. The bearing skidding map 1248 in some examples can contain information such as: i) whether or not skidding occurs under the given operating conditions ii) the extent of the load zone iii) the extent of the sliding contact region iv) the extent of the spin-contact region v) the frequency and/or amplitude of speed fluctuations at which skidding occurs.

Using this skidding map 1248, the method carries out the step 1250 of identifying which operating points across the bearing's operating range are of interest. The “operating points” may be represented by load conditions (such as speed, torque), and/or locations within a bearing (i.e. defining an angle at which skidding occurs). In some examples, the process may determine a separate skidding map 1248 for each bearing. The processing of step 1250 can either be carried out manually (i.e. an engineer looks at the skidding map 1248 and selects operating points), or automatically. Automatically identifying points of interest could be carried out by comparing a value in the skidding map to a threshold value, and proceeding to numerical analysis if the value exceeds the threshold value.

The process can then perform the detailed numerical simulation using a dynamic model 1102, a tribology model 1106, and a thermal model 1126 in a similar way to that described above with reference to FIG. 11. However, in this example, the dynamic model processing block 1201 calculates the dynamic-data based on the operating points that were calculated at step 1250. That is, the input data that is used by the dynamic model processing block 1201 can be determined based on the operating points that were calculated at step 1250. In this way, the numerical analysis is then carried out to further investigate these operating points of interest.

### One Example for Carrying Out the Invention

This invention includes a Software Package allowing engineers to understand the design of any or all of the 3 sub-systems of gearbox, motor and power electronics within a mechanical or electro-mechanical driveline through simulation in order that the driveline performance can be predicted, understood and improved through design modifications. The invention focuses on how the lubricant influences aspects of physical behaviour such as bearing skidding, gear mesh power loss and bearing drag.

Its functionality provides to the design engineer insight on the influence of the lubricant and how it affects the other aspects of driveline performance so that designs can be optimised and confirmed as fit for purpose with a productivity not previously possible. Time and money is saved in the bringing of new products to market and also the problem resolution in existing products. Most importantly, there is the potential to further safeguard human life.

In one aspect, the present invention provides a computer-implemented method of designing a driveline using computer aided engineering. The method comprising the steps of: providing a parametric definition of the driveline; receiving a user selection of one or more types of analysis to be performed; determining which features of the parametric definition be used for the one or more types of analysis selected; creating mathematical models of the driveline from the parametric definition; analysing a performance of the driveline according to the one or more types of analysis to be performed; and in which features of the parametric definition include lubricant properties; whereby a design for making a driveline is produced.

The parametric description, which consists of the form, function, material properties and operating conditions or load-cases, is a greater amount of data than the input data required for these analyses. the parameters necessary for each mathematical model (statics, dynamics, efficiency, thermal, etc.) are extracted. The input data for the tribology model is extracted from the full parametric description of the driveline.

Preferably, the lubricant properties include lubricant viscosity and Eyring shear stress. Lubricant properties are part of the material properties which are defined in the parametric description. They include viscosity and Eyring shear stress of the lubricant.

Preferably, the one or more types of analysis includes calculating of bearing drag and/or clutch friction. The parametric definition of the driveline is taken as the input data to carry out the analysis, which in this case is bearing drag, and is a component of the overall driveline efficiency calculation, or clutch friction, which is a component of the gear shift calculation.

Preferably, the bearing drag calculation and/or clutch friction calculation includes a traction model.

Preferably, the bearing drag calculation includes calculated bearing misalignment as a function of system deflections. Preferably, the system deflections include a function of housing, shaft or non-linear bearing stiffness. The parametric definition contains the data necessary for the static analysis. This is one of the mathematical models that arise from this single definition.

Preferably, a non-uniform temperature distribution is considered.

Preferably, a design target further includes bearing durability or skidding. Preferably, bearing skidding is calculated according to both numerical and analytical methods.

Preferably, a design target further includes gear ratio shifting and/or dynamic clutch engagement Preferably, a limit is set on the performance of the driveline, the limit being an acceptable amount of bearing skidding for the avoidance of wear, fatigue or surface damage

Preferably, a design target further includes gear durability or transmission error or efficiency. Preferably, a design target further includes vibration or noise due to transmission error.

Preferably, the parametric definition includes manufacturing tolerances.

In a further aspect, the invention provides a computer readable product for computer aided engineering design of a driveline, the product comprising code means for implementing the steps of the method of the first aspect of the invention above.

In a further aspect, the invention provides a computer system for computer-aided engineering design of a rotating machine assembly, the system comprising means designed for implementing the steps of the method of the first aspect of the invention above.

### DETAILED DESCRIPTION OF A MODE FOR CARRYING OUT THE INVENTION

Principally, all the key engineering parameters of the gearbox are defined in a single model, including form, function, loadcases and material properties. These are defined in a parametric model that allows rapid redefinition of the design, allowing rapid design-analyse-redesign iterations according to the results of a multiplicity of physical simulations. Each of these simulation results arise from mathematical models of the operating performance of the driveline, with each physical phenomenon requiring a different algorithm, and all algorithms being available within the single package so as to maximise engineering productivity.

A key feature of the invention is that there is a single Parametric Description of the system, from which multiple models for multiple failure mode analyses are derived.

The term Parametric Description is the label applied to the collection of data that defines the product in terms of its form, function, properties and operating conditions. Form includes data relating to geometry; Properties include the material properties of the components, plus component specific properties such as the dynamic capacity of a bearing, the surface roughness of a gear tooth flank, the viscosity of a lubricant, the Goodman diagram of a shaft material, the resistivity of electric motor windings etc.; Operating conditions includes principally the power, speed, torque of the rotating machinery, either as a time history or a residency histogram, but also includes temperature, humidity etc.; Function defines the way in which the product, sub-systems and components perform their primary function, for example, the function of a roller bearing is to provide support to a shaft whilst allowing it to rotate, assemble a shaft and a bearing together and the combined function is to provide a rotating shaft to which loads can be applied, mount a gear on the shaft, mesh it with a similarly mounted gear and the combined function is to change speed and torque (i.e. a gearbox).

TABLE 1
Analysis-Specific Data Selection and the Parametric Description

| | 1300 Parametric Description | | | |
|---|---|---|---|---|
| | 1302 | | 1306 | 1308 |
| | FUNC- | 1304 | PROPER- | OPERATING |
| Analytical Package | TION | FORM | TIES | CONDITIONS |
| 1310 | | Yes | Yes | Yes |
| Multi-body Dynamics & | | | | |
| Finite Element Packages | | | | |
| 1312 | Yes | | Yes | Yes |
| Multi-domain Dynamic | | | | |
| Simulation; Application- | | | | |
| specific vehicle | | | | |
| performance packages | | | | |
| 1314 | | Yes | Yes | |
| CAD | | | | |

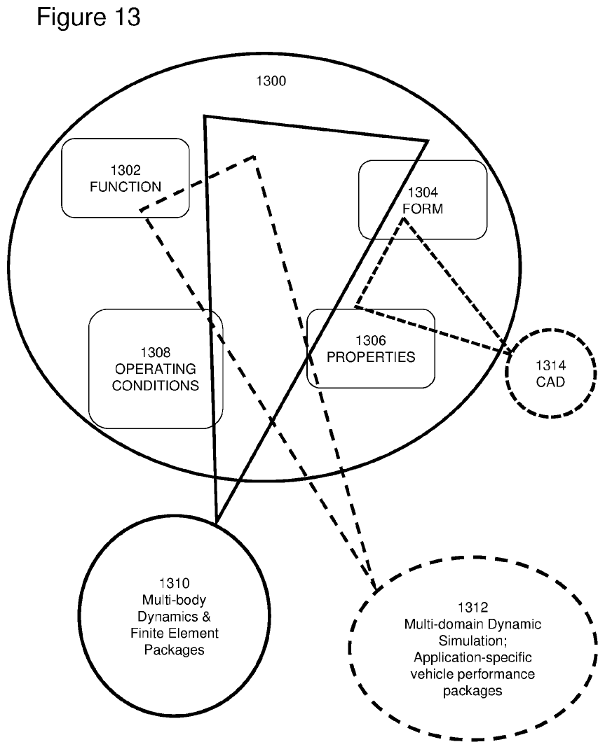

The first row of Table 1 shows a representation of parametric description 1300, formed of four data sets (Function 1302, Form 1304, Properties 1306, and Operating Conditions 1308). FIG. 13 shows a further representation of parametric description 1300, formed of four non-overlapping data sets (Function 1302, Form 1304, Properties 1306, and Operating Conditions 1308). Depending on which analytical package 1310,1312,1314 is used, the engineer has to select data from one or more of the four data sets to create an analytical model suitable for the analysis being performed.

In traditional software packages, CAD provides form (geometry) and some aspects of properties (material density but not Young's Modulus), but it does not include operating conditions or function. Models in Multi-Body Dynamics and Finite Element packages include certain aspects of form, function, properties and operating conditions, but only those that are pertinent to the specific failure mode that is being simulated (see FIG. 1). Models in Multi-domain dynamic simulation also use the aspects of function, properties and operating conditions that are pertinent to the specific failure mode that is being simulated (see FIG. 1), but no form. Models in application specific vehicle simulation packages (e.g. AVL Cruise) are similar to those in Multi-domain dynamic simulation packages, in that they have aspects of function, properties and operating conditions that are pertinent to the specific failure mode that is being simulated (see FIG. 1a), but no form.

Models in Component Specific Packages have Form, and Properties for the component alone, but the Function of that component needs to be understood within the context of the system as a whole. For example, the Function of a bearing is to support the load of a shaft, which sits in a housing, which is supported in a vehicle chassis for example. Without the definition of the shaft and the housing, the definition of the Function can only be implied by artificially defined Operating Conditions such as loads, misalignments.

This is illustrated in FIG. 13, where the relevant data set for analysis 1310 is represented by the triangular set overlapping part Form set 1304, Properties set 1306 and Operating Conditions set 1306 and which, in this example, provides data for multi-body dynamics or finite element packages. Similarly, the relevant data set for analysis 1312 is represented by the triangular set overlapping part of Function set 1302, Properties set 1306 and Operating Conditions set 1308 and which, in this example, provides data for multi-domain dynamic simulation or application-specific vehicle performance packages. Likewise, the relevant data for analysis 1314 is represented by the triangular set overlapping part of Form set 1304 and Properties set 1306 and which provides data for CAD.

In traditional software packages, the absence of at least one of each of the four types of data leads to discontinuities in the work flow within the design process. FIG. 13 illustrates how it is this discontinuity that this invention eliminates.

This document describes an invention which is a software package which more simulates the performance of drivelines, and in particular the impact of lubricant, in unprecedented detail. The engineering impact is that the designer is able to design a driveline which is more efficiency and more durable, with corresponding benefits for the environment, cost and also safety of the passengers on the various modes of transport that employ the drivelines.

The invention is based on an Application Specific Package, in so far as the form, function, material properties and load-cases are defined for the whole driveline system, with a multiplicity of different components being given parametric definitions according to their engineering function. It is this single product definition from which a multiplicity of different mathematical models are derived, to allow a wide range of different performance targets and failure modes to be assessed simultaneously.

The lubricant is described in greater detail than just the viscosity. The Eyring shear stress is included, allowing traction models to be derived which consist of regimes for boundary layer lubrication and elasto-hydrodynamic lubrication, according to the operating conditions.

As is common with Application Specific Packages, the system deflections are calculated accounting for gear loads, non-linear bearing stiffness, shaft deflection, housing deflection and non-uniform temperature distribution. This is used to calculate not only the loads on the bearings but also the misalignments and bearing ring distortion. The load-sharing between the rolling elements in each roller bearing plus the contact pressure distribution between each rolling element and the raceways is calculated.

These values of misalignment, bearing ring distortion and contact pressure distribution are used to calculate the traction forces within the bearing and correspondingly the bearing drag.

The can be calculated in a quasi-static condition, ignoring the inertial forces in the bearing, and this is sufficient for the calculation of bearing drag and its impact on efficiency in many instances.

This calculation of the impact of lubricant on bearings is carried out alongside a calculation of gear mesh efficiency including detailed lubricant definition to FVA 345 or something similar. A substantial interaction between the design of the bearings, design of the gears and design of the lubricant then takes place at different levels.

Gear macro-geometry defines the gear forces within the gearbox for a given transmitted torque and this impacts upon the bearing loads, misalignments, contact pressure between the rolling elements and the raceways and hence the interaction with the lubricant and the impact of the Eyring shear stress on bearing drag.

At the same time, gear macro-geometry affects gear mesh efficiency and hence the power loss mechanism at the gears. Increasing the working pressure angle of a gear increases the efficiency of the gear mesh but puts more load on the bearing and thus may increase the bearing drag, depending on the Eyring shear stress of the oil. This can be investigated and understood. It also impacts gear durability and transmission error. A change in macro-geometry will have an impact upon gear durability, gear transmission error, gear efficiency and bearing drag. The impact on the last two requires a detailed assessment of the oil properties that goes beyond ISO 14179 and this is included in the invention. Changes, such as to the oil formulation and/or gear macro-geometry, need to be assessed with regard to a multiplicity of performance criteria and this invention permits this.

Gear micro-geometry impacts on gear transmission error and the gear mesh efficiency. A designer may choose to improve the gearbox efficiency through modifications to the micro-geometry or changes to the oil specification, the latter of which will affect bearing drag. The invention includes the calculation of gear transmission error and dynamic response of the whole system, thereby allowing the designer to understand all the knock-on influences of any design change across a range of different performance criteria.

The invention also allows the simulation of bearing performance in those operating conditions where dynamic influences become important, for example, wind turbine bearings with rollers with large inertia, and high speed bearings in aerospace, electric motor and machine tool spindle applications where gyroscopic and centrifugal effects become significant.

The load-sharing among the rolling elements, contact condition with the raceways, raceway deflection, misalignment and axial:radial force distribution are all calculated within the context of a mathematical model of the full driveline system, including gear forces, shaft deflections, housing deflections, non-linear bearing stiffness and non-uniform temperature distribution. The contact conditions with the raceways are then used in calculating the traction forces between the rollers and the raceways using a traction model that consists of boundary lubrication, elasto-hydrodynamic lubrication and mixed lubrication, making use of the Eyring shear stress and viscosity of the lubricant.

It predicts the skidding of each roller at each position as the roller proceeds around the roller bearing. Furthermore, it uses this prediction of skidding to predict the reduction in viscosity of the oil, the reduction in film thickness and the onset of wear caused by the skidding.

Skidding prediction is carried out in two ways. The conventional approach of a numerical approach is included, involving a time stepping analysis of the forces, accelerations, velocities and displacements at each time step. This is the most accurate solution possible, but it is time consuming and difficult to use as a design tool since interpretation of the results can sometimes be difficult.

Therefore, a second approach is employed, an analytical solution written in the form of a closed form equation that predicts the onset of skidding. This is much quicker, able to create a skidding “map” in a matter of seconds as opposed to hours or days. It is less accurate approach, but is useful in enabling the designer to understand the mechanism by which skidding occurs and thereby take steps to avoid it. Naturally, when the designer is ready, he/she can check the accuracy of the analytical results by re-running the skidding prediction for the same conditions using the numerical approach.

In practice, both methods are employed. The analytical approach is used to identify conditions where skidding is likely, and also the investigation of possible solutions. It indicates the conditions where it would be productive to run the slow numerical solution. This avoids the problem of estimating a likely skidding condition and running a simulation lasting days only to find that no skidding occurs. The numerical approach is used to confirm this result and understand the severity of skidding.

The invention provides further dynamic analysis including the impact of lubricant in the form of the simulation of clutch engagement. The event of a clutch engagement is to simulate the change in gear speed/ratio and the aim is to understand the comfort of this event for the passengers of, for example, a passenger car.

The simulation consists of a transient dynamic simulation through the shift event, with the clutch/synchroniser torque being calculated as a function of the friction. The coefficient of friction could be a constant value, but the more advanced version uses similar traction models to those used for bearings, which a combination of tribological models consisting of boundary lubrication, elasto-hydrodynamic lubrication and mixed lubrication.

The key advantage is that now the selection of a given lubricant can be interpreted in light of the influence on the shift quality of the gearbox, the efficiency of the driveline and the durability and wear of the gears and bearings. Good clutch engagement requires specific frictional behaviour, especially at low speeds, which may not be generous to gears and bearings, and this trade off in performance can be investigated.

All the simulations described thus far use input values based on a parametric description of the driveline and the parameters set to their nominal values. It is very important to investigate how engineering systems perform as input values vary from the nominal, based on manufacturing tolerances, environmental variation or degradation. The invention provides the facility to apply tolerances to the parametric definition of the driveline in order to understand the behaviour of all manufactured drivelines in all operating and environmental conditions.

All of these simulations provide the design engineer with the possibility to design drivelines that are more efficient, more durable and with better gear shift quality, at the same time as not compromising noise performance. All of this is achieved in a way that minimises the cost of design and development and which minimises the risk of failure in test or in-service use.

Numbered Clauses

1. A computer-implemented method of designing a driveline using computer aided engineering, the method comprising the steps of:

providing a parametric definition of the driveline;

receiving a user selection of one or more types of analysis to be performed;

determining which features of the parametric definition be used for the one or more types of analysis selected;

creating mathematical models of the driveline from the parametric definition;

analysing a performance of the driveline according to the one or more types of analysis to be performed;

and in which features of the parametric definition include lubricant properties;

whereby a design for making a driveline is produced.

2. A method according to clause 1, in which the lubricant properties include lubricant viscosity and Eyring shear stress.

3. A method according to clause 2 in which the one or more types of analysis includes calculating of bearing drag and/or clutch friction.

4. A method according to clause 3, in which the bearing drag calculation and/or clutch friction calculation includes a traction model.

5. A method according to clause 3 or clause 4, in which the bearing drag calculation includes calculated bearing misalignment as a function of system deflections.

6. A method according to clause 5, in which the system deflections include a function of housing, shaft or non-linear bearing stiffness.

7. A method according to clause 5 or 6, in which a non-uniform temperature distribution is considered.

8. A method according to any previous clause in which a design target further includes bearing durability or skidding.

9. A method according to clause 8 in which bearing skidding is calculated according to both numerical and analytical methods.

10. A method according to clause 3 or 5 in which a design target further includes gear ratio shifting and/or dynamic clutch engagement

11. A method according to any previous clause in which a limit is set on the performance of the driveline, the limit being an acceptable amount of bearing skidding for the avoidance of wear, fatigue or surface damage

12. A method according to any previous clause in which a design target further includes gear durability or transmission error or efficiency

13. A method according to clause 11 in which a design target further includes vibration or noise due to transmission error

14. A method according to any previous clause in which the parametric definition includes manufacturing tolerances.

15. A computer readable product for computer aided engineering design of a driveline, the product comprising code means for implementing the steps of the method according to any of clauses 1 to 14.

16. A computer system for computer-aided engineering design of a rotating machine assembly, the system comprising means designed for implementing the steps of the method according to any of clauses 1 to 14.

There may also be provided:

A computer-implemented method of designing a driveline using computer aided engineering, the method comprising the steps of:

providing a parametric definition of the driveline, in which features of the parametric definition include lubricant viscosity and surface roughness;

a user specifying one or more types of analysis to be performed; and

analysing a performance of the driveline according to the one or more type of analysis to be performed;

in which one of the mathematical models is a tribology model and one of the types of analysis is a tribology analysis;

whereby a design for making a driveline is produced.

Analysing a performance of the driveline can include analysing against a design target.

The tribology analysis can include calculating bearing drag and/or clutch friction.

The bearing drag calculation and/or clutch friction calculation can include a traction model.

The traction model may be an Eyring model.

The bearing drag calculation may include calculated bearing misalignment as a function of system deflections.

The system deflections may include a function of housing, shaft or non-linear bearing stiffness.

A temperature distribution across the driveline may be a non-uniform distribution.

The design target may include bearing durability or skidding.

The type of analysis may be bearing skidding. The mathematical model may combine numerical and analytical methods.

A design target may further include gear ratio shifting and/or dynamic clutch engagement.

A limit may be set on the performance of the driveline. The limit may be an acceptable amount of bearing skidding for the avoidance of wear, fatigue or surface damage.

A design target may further include gear durability or transmission error or efficiency.

A design target may further include vibration or noise due to transmission error.

A method may comprise an additional step of modifying a feature of the parametric definition and repeating analysing the performance of the driveline until the performance is within a user-specified range.

1. A computer-implemented method for modelling a driveline, the driveline comprising a plurality of components, the method comprising the steps of:
a) receiving a parametric description of the driveline;
b) creating a tribology model of the driveline from the parametric description;
c) calculating one or more traction coefficients for one or more components of the driveline using the tribology model; and
d) calculating a performance metric of the driveline, where the calculation is based on the parametric description and the one or more traction coefficients.

2. The method of claim 1, wherein creating a tribology model comprises:
running a dynamic model using data from the parametric description in order to determine dynamic-data;
determining a lubricant film thickness parameter by processing the dynamic-data and also the parametric description;
determining a lubrication regime based on the lubricant film thickness parameter;
identifying a traction model that is appropriate for the determined lubrication regime; and
processing the traction model, the parametric description and the dynamic-data to calculate at least a subset of the traction coefficients.

3. The method of claim 1, wherein:
calculating the performance metric comprises building a performance-metric-model, and wherein the method further comprises:
creating the tribology model and building the performance-metric-model such that they have a common structure.

4. The method of claim 1, further comprising:
comparing the performance metric with one or more loop-end-conditions; and
if the one or more loop-end-conditions are not satisfied, then:
updating the parametric description based on the performance metric.

5. The method of claim 1, further comprising:
creating a thermal model of the driveline from the parametric description;
calculating a temperature distribution for one or more components of the driveline using the thermal model;
calculating the performance metric of the driveline based on either or both of the temperature distribution and the one or more traction coefficients.

6-8. (canceled)

9. The method of claim 1, further comprising:
creating an efficiency model of the driveline from the parametric description;
calculating an efficiency metric using the efficiency model;
calculating the performance metric of the driveline based on either or both of the efficiency metric and the one or more traction coefficients.

10. The method of claim 9, further comprising:
creating the efficiency model of the driveline from the parametric description and also based on the one or more traction coefficients.

11. The method of claim 9, further comprising:
creating a thermal model of the driveline from the parametric description;
calculating a temperature distribution for one or more components of the driveline using the thermal model;
calculating the performance metric of the driveline based on either or both of the temperature distribution and the one or more traction coefficients.

12. The method of claim 11, further comprising:
creating the thermal model of the driveline from the parametric description and also based on the one or more traction coefficients and/or the efficiency metric.

13. The method of claim 11, further comprising:
creating the efficiency model of the driveline from the parametric description and also based on the temperature distribution for one or more components of the driveline.

14. The method of claim 1, further comprising:
creating a structural model of the driveline from the parametric description;
determining a deflection of one or more components of the driveline based on the structural model; and
calculating the performance metric of the driveline based on either or both of the one or more traction coefficients and the determined deflection of the one or more components.

15. The method of claim 14, further comprising:
creating the tribology model of the driveline from the parametric description and also based on the determined deflection of the one or more components.

16. The method of claim 14, further comprising:
creating a thermal model of the driveline from the parametric description;
calculating a temperature distribution for one or more components of the driveline using the thermal model;
optionally, calculating the performance metric of the driveline also based on the temperature distribution.

17. The method of claim 16, further comprising:
creating the structural model of the driveline from the parametric description and also based on the temperature distribution.

18. The method of claim 14, further comprising:
creating an efficiency model of the driveline from the parametric description;
calculating an efficiency metric using the efficiency model;
optionally, calculating the performance metric of the driveline also based on the efficiency metric.

19. The method of claim 14, further comprising:
creating the efficiency model of the driveline also based on one or more of: the temperature distribution, the traction coefficients, and the determined deflection of the one or more components.

20. The method of claim 1, wherein the driveline comprises at least one bearing, further comprising:
calculating one or more traction coefficients for one or more components of the driveline using the tribology model, and also based on one or both of a temperature distribution and dynamic-data;
calculating a temperature distribution based on the parametric description of the driveline, and one or both of the traction coefficients and the dynamic-data;
calculating the dynamic-data based on the parametric description of the driveline, and one or both of the temperature distribution and the traction coefficients; and
calculating a bearing skidding performance metric of the driveline based on any or all of the parametric description, the one or more traction coefficients, the dynamic-data, and the temperature distribution.

21. The method of claim 1, wherein the driveline comprises at least one bearing, the method further comprising:
building and running an analytical model of the bearing based on the parametric description to determine a bearing skidding map;
identifying operating points across the bearing's operating range based on the skidding map;
calculating one or more traction coefficients for one or more components of the driveline using the tribology model for the identified operating points, and also based on one or both of a temperature distribution and dynamic-data;
calculating a temperature distribution based on the parametric description of the driveline, and one or both of the traction coefficients and the dynamic-data;
calculating the dynamic-data based on the parametric description of the driveline, and one or both of the temperature distribution and the traction coefficients; and
calculating a bearing skidding performance metric of the driveline based on any or all of the parametric description, the one or more traction coefficients, the dynamic-data, and the temperature distribution.

22-24. (canceled)

25. A computer readable product for computer aided engineering design of a driveline, the product comprising code means for implementing the steps of the method according to claim 1.

26. A computer system for computer-aided engineering design of a driveline, the system comprising means designed for implementing the steps of the method according to claim 1.

27. (canceled)
